(19) United States
(12) Patent Application Publication
(10) Pub. No.: US 2026/0162079 A1
(43) Pub. Date: Jun. 11, 2026

(54) Integrated Deposit Return Management System

(71) Applicant: Jonah E. Saltzman, Wallkill, NY (US)

(72) Inventor: Jonah E. Saltzman, Wallkill, NY (US)

(21) Appl. No.: 19/412,984

(22) Filed: Dec. 9, 2025

Related U.S. Application Data
(60) Provisional application No. 63/729,962, filed on Dec. 10, 2024.

(51) Int. Cl. G06Q 10/30; G06K 7/14; G06Q 10/087; G06Q 30/018; G06Q 40/02

(52) U.S. Cl. CPC G06Q 10/30; G06K 7/1417; G06Q 10/08726; G06Q 30/018; G06Q 40/022

(57) ABSTRACT

A deposit return management system comprising a central processing system with at least one processor and memory configured to manage data communications and transaction processing, and a database storing container identification data, user account data, deposit configuration data, and transaction records. An enterprise application module includes a deposit configuration interface for defining deposit structures with deposit values and allocations among stakeholder entities, and a stakeholder management component for maintaining stakeholder-deposit associations. A consumer application module operates on a user computing device and includes a user account component maintaining deposit balance data and an identifier recognition component for capturing identifier data from containers bearing machine-readable identifiers. A partner application programming interface enables data exchange with external systems. The central processing system receives captured identifier data from the consumer application module, retrieves corresponding container data from the database, and associates containers with user accounts.

### CROSS-REFERENCE TO RELATED APPLICATIONS

This application claims the benefit of U.S. Provisional Patent Application No. 63/729,962, filed on 10 Dec. 2024.

### FIELD OF INVENTION

The present invention relates to recycling and waste management systems. More particularly, the invention relates to systems and methods for implementing and managing deposit return schemes through integrated digital platforms comprising enterprise configuration tools and consumer-facing applications.

### BACKGROUND

The growing global challenges of resource depletion, environmental degradation, and waste accumulation have placed increasing pressure on governments, manufacturers, and consumers to adopt more sustainable practices. Recycling programs represent a critical component of modern environmental policy, seeking to reduce landfill waste, conserve natural resources, and minimize the carbon footprint associated with manufacturing virgin materials. Among the various approaches to incentivizing recycling behavior, deposit return systems have emerged as one of the more effective mechanisms for encouraging consumers to return containers and packaging for reuse or recycling. These systems operate on the principle of assigning a monetary value to containers at the point of sale, which consumers can recover upon returning the containers to designated collection points. Despite their demonstrated effectiveness in jurisdictions where they have been implemented, deposit return systems face significant limitations that have hindered their widespread adoption and optimal performance.

Traditional deposit return systems have historically been developed and deployed on a jurisdiction-by-jurisdiction basis, resulting in a fragmented landscape of incompatible programs with varying deposit values, eligible materials, collection infrastructure, and redemption processes. This regional inconsistency creates substantial challenges for manufacturers and distributors who must navigate disparate regulatory requirements across multiple territories, often necessitating distinct packaging, labeling, and tracking mechanisms for each jurisdiction in which they operate. Consumers who travel or relocate between regions frequently encounter confusion regarding which containers are eligible for deposit returns, where collection points are located, and how to recover their deposits in unfamiliar systems. The lack of standardization and interoperability among existing deposit return systems has impeded the development of unified national or international recycling frameworks that could otherwise achieve greater economies of scale and environmental impact.

The technological infrastructure underlying conventional deposit return systems has generally failed to keep pace with advances in digital technology, data analytics, and consumer-facing applications that have transformed other sectors of commerce and logistics. Many existing systems rely predominantly on physical infrastructure such as reverse vending machines and manual collection centers without meaningful integration with digital platforms that could enhance tracking, verification, and user engagement. The absence of robust data collection and analytics capabilities limits the ability of system operators, manufacturers, and policymakers to monitor performance metrics, identify optimization opportunities, and demonstrate compliance with extended producer responsibility regulations. Furthermore, traditional systems typically provide consumers with limited visibility into their deposit balances, redemption options, and environmental impact, resulting in a transactional experience that fails to foster sustained engagement with recycling behaviors.

Fraud prevention represents another significant challenge that has plagued deposit return systems since their inception. Counterfeit labels, duplicated receipts, cross-border arbitrage involving containers from jurisdictions with lower or no deposits, and manipulation of collection equipment have resulted in substantial financial losses and undermined the integrity of deposit return programs. Existing fraud detection mechanisms are often reactive rather than proactive, relying on periodic audits or obvious anomalies rather than sophisticated real-time monitoring and algorithmic analysis of transaction patterns. The financial impact of fraud not only reduces the funds available for recycling operations and environmental initiatives but also erodes stakeholder confidence in the viability and fairness of deposit return systems as a policy mechanism.

It is within this context that the present invention is provided.

### SUMMARY

The present invention provides a deposit return management system that addresses the limitations of existing recycling and deposit return schemes through an integrated platform combining enterprise-level configuration capabilities, consumer-facing engagement tools, and extensible connectivity with external systems. The system comprises a central processing system having at least one processor and at least one memory configured to manage data communications and transaction processing across the platform. A database in communication with the central processing system stores container identification data, user account data, deposit configuration data, and transaction records, providing a unified data repository that enables consistent tracking and management of containers throughout their lifecycle.

The system further comprises an enterprise application module in communication with the central processing system, which includes a deposit configuration interface configured to receive input defining a deposit structure comprising at least a deposit value and an allocation of portions of the deposit value among a plurality of stakeholder entities. A stakeholder management component within the enterprise application module stores and maintains data associating each stakeholder entity with its respective portion of the deposit value. A consumer application module configured to operate on a user computing device communicates with the central processing system and includes a user account component for maintaining deposit balance data and an identifier recognition component for capturing identifier data from containers bearing machine-readable identifiers. A partner application programming interface enables data exchange with external systems, facilitating integration with existing infrastructure. The central processing system receives captured identifier data from the consumer application module, retrieves corresponding container data from the database, and associates containers with user accounts, thereby enabling seamless tracking of deposits from point of purchase through redemption.

In some embodiments, the enterprise application module further comprises a system design interface configured to receive input defining a plurality of stakeholder roles and one or more operational relationships between the plurality of stakeholder roles. This feature enables system operators to configure complex multi-party deposit return schemes that accurately reflect the commercial and logistical relationships among participants in the recycling ecosystem.

In further embodiments, the system design interface further comprises a visual workspace component configured to display a graphical representation of the plurality of stakeholder roles and the one or more operational relationships. The visual workspace simplifies the configuration of deposit return schemes by providing an intuitive interface that allows operators to comprehend and modify complex stakeholder networks without requiring specialized technical expertise.

In some embodiments, the enterprise application module further comprises an extended producer responsibility dashboard configured to retrieve stakeholder-specific data from the database and generate compliance status information based on jurisdictional regulatory requirements. This dashboard provides manufacturers and other responsible parties with the tools necessary to monitor and demonstrate their compliance with increasingly complex environmental regulations across multiple jurisdictions.

In yet further embodiments, the extended producer responsibility dashboard further comprises a metrics display component configured to retrieve and display a plurality of performance metrics including at least one of a materials collection quantity, an items collection count, a carbon emissions savings value, and a user participation count. The metrics display enables stakeholders to quantify their environmental impact and track progress toward sustainability goals with granular visibility into key performance indicators.

In some embodiments, the enterprise application module further comprises an analytics module configured to receive operational data from a plurality of collection facilities and generate one or more operational recommendations based on a comparison of performance metrics between the plurality of collection facilities. This analytics capability enables system operators to identify underperforming facilities, share best practices across the network, and continuously optimize collection operations.

In further embodiments, the enterprise application module further comprises an inventory management module configured to track inventory levels for a plurality of reusable containers and generate restocking recommendations based on calculated return rates. The inventory management module supports circular economy initiatives by ensuring adequate supply of reusable containers while minimizing excess inventory and associated costs.

In some embodiments, the consumer application module further comprises a dynamic deposit adjustment component configured to receive user input selecting a deposit value within a predefined deposit value range for a container and transmit the selected deposit value to the central processing system. This feature empowers consumers to voluntarily increase deposit values on containers, enabling enhanced incentivization for recycling and providing flexibility to accommodate varying levels of consumer commitment to sustainability.

In yet further embodiments, the database is configured to store a plurality of jurisdiction identifiers each associated with a respective jurisdiction-specific deposit configuration, and the consumer application module is configured to maintain a plurality of separate deposit balances for the user account corresponding to respective jurisdiction identifiers. This regional balance management capability accommodates the fragmented regulatory landscape of deposit return systems by ensuring that deposits earned in one jurisdiction remain appropriately segregated and redeemable according to local requirements.

In some embodiments, the central processing system further comprises a dynamic pricing module configured to calculate an adjusted deposit value based on real-time data relating to at least one of recycling rates, material demand, and environmental impact metrics. Dynamic pricing enables the system to respond to market conditions and environmental priorities by adjusting incentive levels to encourage recycling behavior where and when it is most needed.

In further embodiments, the machine-readable identifier comprises a primary identifier disposed on a first surface of the container and a secondary identifier disposed on a bottom surface of the container. The dual-identifier configuration provides redundancy that enhances scanning reliability and enables identification in diverse operational contexts including retail environments and automated processing facilities.

In some embodiments, the machine-readable identifier comprises a circumferential code disposed around a circumference of the container, the circumferential code comprising a repeating sequential pattern including a plurality of visual orientation markers and a plurality of data elements. The circumferential encoding scheme enables containers to be scanned from any rotational orientation, substantially improving throughput in high-speed processing environments and reducing errors associated with container alignment.

In yet further embodiments, the system further comprises a crate assembly comprising a crate body configured to hold a plurality of containers, wherein the crate body comprises a plurality of apertures positioned to expose machine-readable identifiers disposed on bottom surfaces of the plurality of containers. The crate assembly design facilitates bulk processing of containers while maintaining individual container traceability throughout the collection and processing workflow.

In further embodiments, the system further comprises a machine vision system comprising at least one imaging device positioned to capture images of the machine-readable identifiers through the plurality of apertures, wherein the machine vision system is in communication with the central processing system via the partner application programming interface. The machine vision system enables automated identification of multiple containers simultaneously, increasing processing efficiency and reducing labor requirements at collection and sorting facilities.

In some embodiments, the partner application programming interface is configured to receive transaction data from a point of sale system and receive user identification data obtained from at least one of a scanned code displayed by the consumer application module and a near-field communication exchange with the user computing device. This point of sale integration enables automatic association of purchased containers with user accounts at the time of purchase, eliminating the need for subsequent manual entry and improving the accuracy of deposit tracking.

In yet further embodiments, the consumer application module further comprises a receipt processing component configured to capture an image of a receipt and extract product identification data from the receipt using optical character recognition. The receipt processing capability provides an alternative mechanism for associating containers with user accounts when direct point of sale integration is not available, expanding the accessibility of the system to retailers with varying levels of technological infrastructure.

In some embodiments, the system further comprises an automated telephony system in communication with the central processing system, the automated telephony system configured to receive transaction identifier input from a user via telephone keypad signals and generate a unique authorization code. The telephony interface ensures that users without access to smartphones or internet connectivity can participate in the deposit return system, promoting inclusivity and maximizing participation across diverse user populations.

In further embodiments, the central processing system further comprises a fraud detection module configured to monitor transaction data stored in the database for anomalous patterns and generate an alert upon detection of an anomalous pattern. The fraud detection capability protects the integrity of the deposit return system by identifying suspicious activities such as counterfeit labels, duplicated redemptions, and other forms of abuse before they result in significant financial losses.

In some embodiments, the central processing system further comprises a volume prediction module configured to apply a predictive model to historical collection data to generate predicted collection volumes for a plurality of collection facilities. Volume prediction enables proactive management of collection infrastructure by anticipating capacity constraints and enabling load balancing across the facility network.

In yet further embodiments, the consumer application module further comprises a routing optimization component configured to calculate a plurality of route options from a user location to one or more collection facilities and apply an optimization algorithm based on at least one of distance, estimated travel time, and estimated carbon emissions. The routing optimization feature enhances user convenience while minimizing the environmental footprint associated with container returns by directing users to appropriate facilities via efficient routes.

### BRIEF DESCRIPTION OF THE DRAWINGS

Various embodiments of the invention are disclosed in the following detailed description and accompanying drawings.

FIG. 1 illustrates an example architectural overview of the deposit return management system showing the primary components and their interconnections.

FIG. 2A illustrates an example user journey depicting the lifecycle of a container from purchase through deposit refund.

FIG. 2B illustrates an example association between a user and a uniquely identifiable product within the system.

FIG. 2C illustrates an example implementation of the system within a circular reuse model for beverage containers.

FIG. 2D illustrates an example cost structure breakdown for a product showing deposit allocations among stakeholder entities.

FIG. 3A illustrates an example system design interface for configuring deposit return schemes within the enterprise application module.

FIG. 3B illustrates an example deposit configuration interface for defining financial allocations among stakeholders.

FIG. 3C illustrates an example deposit configuration interface with assigned stakeholder amounts.

FIG. 3D illustrates an example extended producer responsibility dashboard displaying compliance metrics and performance data.

FIG. 3E illustrates an example analytics module for benchmarking collection facility performance.

FIG. 3F illustrates an example inventory management module for tracking reusable container stock levels.

FIG. 4A illustrates an example integration between a point of sale system and the consumer application module during purchase.

FIG. 4B illustrates an example return process using a return machine system connected via the partner application programming interface.

FIG. 4C illustrates an example device-to-device interaction between consumer and enterprise devices.

FIG. 4D illustrates an example user journey flowchart showing multiple pathways for deposit activation and redemption.

FIG. 5A illustrates an example dynamic deposit adjustment component enabling user-selected deposit values.

FIG. 5B illustrates an example regional balance management interface displaying jurisdiction-specific deposit balances.

FIG. 5C illustrates an example dynamic pricing module for adjusting deposit values based on real-time data.

FIG. 6A illustrates an example volume prediction module for forecasting collection facility capacity and load balancing.

FIG. 6B illustrates an example routing optimization component for calculating environmentally efficient routes to collection facilities.

FIG. 7 illustrates an example scanning and identification process for associating containers with user accounts.

FIG. 8A illustrates an example scanning process for multi-item packaging at a point of sale.

FIG. 8B illustrates an example display of reuse history and environmental impact data for reusable containers.

FIG. 8C illustrates an example crate system with integrated machine vision scanning capabilities.

FIG. 8D illustrates an example container with a machine-readable identifier disposed on the bottom surface.

FIG. 8E illustrates an example bottom view of a crate system showing exposed container identifiers.

FIG. 9A illustrates an example circumferential code disposed around the circumference of a container.

FIG. 9B illustrates an example detailed structure of a circumferential code showing orientation markers and data elements.

FIG. 10 illustrates an example configuration of the system across multiple jurisdictions with varying deposit regulations.

FIG. 11A illustrates an example receipt processing component for associating purchases with user accounts.

FIG. 11B illustrates an example automated telephony system for non-smartphone user interaction.

FIG. 11C illustrates an example flowchart for receipt verification through the automated telephony system.

FIG. 12A illustrates an example notification component for reminding users to return containers.

FIG. 12B illustrates an example fraud detection module for identifying suspicious transaction patterns.

FIG. 13 illustrates an example advertisement component for displaying personalized promotional content.

FIG. 14 illustrates an example marketplace component for stakeholder procurement of containers.

FIG. 15 illustrates an example redemption and marketplace component for acquiring and reselling digital assets.

FIG. 16 illustrates an example gamification module providing interactive gaming functionality.

FIG. 17 illustrates an example digital asset generation component for creating personalized digital rewards.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### DEFINITIONS

The terminology used herein is for the purpose of describing particular embodiments only and is not intended to be limiting of the invention.

As used herein, the term “and/or” includes any combinations of one or more of the associated listed items.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The term “central processing system” refers to any computing infrastructure capable of executing software instructions and managing data communications. This includes, but is not limited to, single servers, distributed server architectures, cloud computing platforms, edge computing nodes, and hybrid computing environments. In one example implementation, the central processing system may comprise a plurality of virtual machines hosted on a cloud computing platform such as Amazon Web Services, Microsoft Azure, or Google Cloud Platform, with load balancing and automatic scaling capabilities to accommodate variable transaction volumes.

The term “database” refers to any organized collection of data stored electronically and accessible by the central processing system. This includes, but is not limited to, relational databases, non-relational databases, distributed databases, in-memory databases, and graph databases. In one example implementation, the database may comprise a PostgreSQL relational database for transactional data combined with a MongoDB document store for flexible container metadata storage. In another example implementation, the database may comprise a distributed database system such as Apache Cassandra or Amazon DynamoDB to provide high availability and horizontal scalability across geographic regions.

The term “enterprise application module” refers to any software component or collection of software components that provide functionality directed toward organizational stakeholders rather than individual consumers. This includes, but is not limited to, web-based applications, desktop applications, mobile applications designed for business users, and application programming interfaces accessible by enterprise systems. In one example implementation, the enterprise application module may comprise a web application accessible via standard web browsers and built using technologies such as React, Angular, or Vue.js for the frontend, with a backend implemented using Node.js, Python, Java, or similar server-side technologies.

The term “consumer application module” refers to any software component or collection of software components that provide functionality directed toward individual end users participating in the deposit return system. This includes, but is not limited to, native mobile applications for iOS and Android platforms, progressive web applications, hybrid mobile applications, and web-based applications optimized for mobile devices. In one example implementation, the consumer application module may comprise native applications developed using Swift for iOS devices and Kotlin for Android devices, with shared business logic implemented using a cross-platform framework such as React Native or Flutter.

The term “user computing device” refers to any electronic device capable of executing the consumer application module and communicating with the central processing system. This includes, but is not limited to, smartphones, tablet computers, personal computers, wearable computing devices, and dedicated kiosk terminals. In one example implementation, the user computing device may comprise an Apple iPhone or Samsung Galaxy smartphone equipped with a camera, near-field communication capability, and cellular or wireless network connectivity.

The term “machine-readable identifier” refers to any marking, code, tag, or other element disposed on a container that encodes information capable of being captured and decoded by electronic means. This includes, but is not limited to, one-dimensional barcodes such as UPC and EAN codes, two-dimensional codes such as QR codes and Data Matrix codes, radio-frequency identification tags, near-field communication tags, laser-etched markings, and proprietary encoding schemes. In one example implementation, the machine-readable identifier may comprise a QR code printed on a label affixed to the container, the QR code encoding a unique container identifier, product type, manufacturer identifier, and jurisdiction code. In another example implementation, the machine-readable identifier may comprise an RFID tag embedded in the container wall, enabling identification without direct line-of-sight scanning.

The machine-readable identifier may comprise a single identifier or a plurality of identifiers disposed on one or more surfaces of the container. In some embodiments, the machine-readable identifier comprises only a primary identifier, such as a universal product code (UPC) or other standard barcode, disposed on a first surface of the container. In other embodiments, the machine-readable identifier comprises a primary identifier and a secondary identifier, wherein the secondary identifier comprises a system-specific identifier such as a two-dimensional code encoding container-specific data for use with the deposit return management system 100. In further embodiments, the machine-readable identifier comprises a primary identifier, a secondary identifier, and a tertiary identifier disposed on distinct surfaces of the container, such as a first surface, a side surface, and a bottom surface respectively. The tertiary identifier may provide redundancy or encode additional information accessible when the container is positioned in a particular orientation.

The identifier recognition component is configured to capture identifier data from any one identifier or any combination of identifiers comprising the machine-readable identifier. In some embodiments, the identifier recognition component captures identifier data from only the primary identifier, such as when scanning a standard product barcode. In other embodiments, the identifier recognition component captures identifier data from only the secondary identifier, such as when the primary identifier is obscured, damaged, or not present. In further embodiments, the identifier recognition component captures identifier data from a combination of identifiers, such as the primary identifier and the secondary identifier, to enable cross-validation or to obtain complementary information encoded across multiple identifiers. This flexibility enables the deposit return management system 100 to operate with containers bearing varying identifier configurations and to accommodate different scanning contexts and equipment capabilities.

The term “identifier recognition component” refers to any hardware or software element, or combination thereof, capable of capturing and decoding machine-readable identifiers. This includes, but is not limited to, camera modules with associated image processing software, dedicated barcode scanners, RFID readers, and near-field communication interfaces. In one example implementation, the identifier recognition component may comprise the camera of a smartphone combined with image processing algorithms implemented using computer vision libraries such as OpenCV or platform-specific frameworks such as Apple Vision or Google ML Kit.

The term “container” refers to any vessel, packaging, or receptacle for which a deposit may be assigned within the deposit return system. This includes, but is not limited to, glass bottles, plastic bottles, aluminum cans, steel cans, beverage cartons, food containers, and reusable packaging of various materials. The container may be configured for single use followed by recycling or for multiple reuse cycles with intermediate washing or sanitization. In one example implementation, the container may comprise a glass beverage bottle having a capacity of 330 milliliters, composed of soda-lime glass, and bearing both a paper label with a printed QR code and a laser-etched code on the bottle base.

The term “deposit structure” refers to the collection of parameters that define how deposits are valued, allocated, and managed within a particular configuration of the deposit return system. This includes, but is not limited to, the base deposit value, allocations to various stakeholder entities, handling fees, administrative fees, and any variable components that may be adjusted based on market conditions or policy objectives. In one example implementation, the deposit structure may specify a total deposit of twenty-five cents per container, with fifteen cents allocated as a refundable consumer deposit, five cents allocated to recycling facility operators as a handling fee, three cents allocated to system administration, and two cents allocated to an environmental fund.

The term “stakeholder entity” refers to any organization, business, governmental body, or other party that participates in the deposit return system in a defined role. This includes, but is not limited to, consumers, retailers, manufacturers, distributors, recycling facility operators, deposit system operators, cooperative organizations, transportation service providers, washing service providers, and governmental regulatory authorities. The stakeholder management component may maintain data for hundreds or thousands of individual stakeholder entities, each associated with one or more stakeholder roles and corresponding deposit allocations.

The term “partner application programming interface” refers to any programmatic interface that enables external systems to exchange data with the central processing system. This includes, but is not limited to, RESTful APIs, GraphQL APIs, SOAP web services, message queue interfaces, and webhook-based event notification systems. In one example implementation, the partner application programming interface may comprise a RESTful API secured using OAuth 2.0 authentication, with endpoints for registering transactions, validating container identifiers, querying deposit balances, and receiving real-time event notifications via webhooks.

The term “point of sale system” refers to any hardware or software system used by retailers to process sales transactions. This includes, but is not limited to, traditional cash registers, electronic point of sale terminals, mobile point of sale devices, self-checkout kiosks, and e-commerce checkout systems. In one example implementation, the point of sale system may comprise a retail terminal running software from providers such as Square, Clover, or Shopify, integrated with the deposit return management system via the partner application programming interface.

The term “near-field communication” refers to a set of communication protocols that enable two electronic devices to establish communication by bringing them within close proximity, typically within a range of four centimeters or less. Near-field communication may be used to exchange user identification data between the user computing device and point of sale systems, return processing devices, or other system components. In one example implementation, near-field communication may be implemented using NFC-A, NFC-B, or NFC-F protocols as defined by the NFC Forum specifications.

The term “circumferential code” refers to a machine-readable identifier that extends around the circumference of a container in a repeating pattern, enabling the identifier to be captured and decoded regardless of the rotational orientation of the container. The circumferential code may comprise visual orientation markers that enable scanning systems to determine the alignment of the code, and data elements that encode the container identification information. In one example implementation, the circumferential code may comprise a repeating pattern of Data Matrix code segments interspersed with distinctive square orientation markers, printed as a band around the lower portion of a bottle using ink-jet printing or laser etching techniques.

The term “machine vision system” refers to any system comprising one or more imaging devices and associated processing components capable of capturing images and extracting information therefrom. This includes, but is not limited to, industrial camera systems, line-scan cameras, area-scan cameras, and multi-camera arrays with associated lighting and image processing hardware or software. In one example implementation, the machine vision system may comprise a plurality of high-speed cameras positioned beneath a conveyor system, capturing images of container bases as they pass overhead, with image processing performed by dedicated vision processing hardware or general-purpose computing hardware running computer vision software.

The term “crate assembly” refers to any container or structure designed to hold a plurality of individual containers for transport, storage, or processing. This includes, but is not limited to, plastic crates, cardboard boxes, metal baskets, and palletized assemblies. In one example implementation, the crate assembly may comprise a high-density polyethylene crate having internal dividers that define individual compartments for twenty-four bottles, with apertures in the base of each compartment sized to expose machine-readable identifiers on the bottle bases while securely retaining the bottles during handling and transport. The apertures of the crate assembly may be positioned to expose machine-readable identifiers disposed on any suitable surface of the containers. In some embodiments, the apertures are positioned in a base of the crate body to expose machine-readable identifiers disposed on bottom surfaces of the containers. In other embodiments, the apertures are positioned in side walls of the crate body to expose machine-readable identifiers disposed on side surfaces of the containers. In further embodiments, the apertures are positioned in a top portion or lid of the crate body to expose machine-readable identifiers disposed on top surfaces or shoulder regions of the containers. The positioning of apertures corresponds to the location of machine-readable identifiers on the particular containers to be held by the crate assembly, accommodating containers that lack a clear bottom surface or for which identifier placement on an alternative surface is more convenient for manufacturing, scanning, or handling purposes.

The term “optical character recognition” refers to any technology capable of extracting text information from images. This includes, but is not limited to, template-based recognition systems, feature-based recognition systems, and neural network-based recognition systems. In one example implementation, optical character recognition may be performed using cloud-based services such as Google Cloud Vision, Amazon Textract, or Microsoft Azure Computer Vision, or using on-device processing with libraries such as Tesseract or platform-specific recognition frameworks.

The term “automated telephony system” refers to any system capable of conducting automated voice interactions with users over telephone networks. This includes, but is not limited to, interactive voice response systems, voice-over-IP systems, and hybrid systems combining traditional telephony with internet-based communications. In one example implementation, the automated telephony system may comprise a cloud-based interactive voice response platform such as Twilio, Amazon Connect, or Genesys, configured with voice prompts and dual-tone multi-frequency signal detection to guide users through transaction verification processes.

The term “fraud detection module” refers to any software component or system configured to identify potentially fraudulent activities within the deposit return system. This includes, but is not limited to, rule-based detection systems, statistical anomaly detection systems, and machine learning-based detection systems. In one example implementation, the fraud detection module may comprise a combination of rule-based triggers for obvious violations such as duplicate container scans, together with machine learning models trained on historical transaction data to identify subtle patterns indicative of fraudulent behavior.

The term “volume prediction module” refers to any software component or system configured to generate predictions of future collection volumes at collection facilities. This includes, but is not limited to, time-series forecasting models, regression models, and machine learning models. In one example implementation, the volume prediction module may employ recurrent neural networks or transformer-based models trained on historical collection data, seasonal patterns, local event calendars, and weather data to generate hourly or daily predictions of expected collection volumes.

The term “routing optimization component” refers to any software component configured to calculate and recommend routes for users traveling to collection facilities. This includes, but is not limited to, shortest-path algorithms, traffic-aware routing algorithms, and multi-objective optimization algorithms that consider factors beyond simple distance. In one example implementation, the routing optimization component may integrate with mapping and navigation services such as Google Maps, Apple Maps, or OpenStreetMap to obtain real-time traffic data and calculate routes that minimize travel time, distance, or estimated carbon emissions based on user preferences.

The term “dynamic pricing module” refers to any software component configured to adjust deposit values or incentive levels based on real-time or near-real-time data. This includes, but is not limited to, rule-based adjustment systems, algorithmic pricing systems, and machine learning-based systems that learn optimal pricing strategies from historical data. In one example implementation, the dynamic pricing module may increase deposit values for specific materials when commodity prices rise or when recycling rates in a particular region fall below target levels, thereby providing enhanced incentives precisely when and where they are most needed.

Unless expressly stated otherwise, words such as “a,” “an,” and “the” are intended to include both singular and plural forms, and the term “about” is intended to accommodate ±10% variations in stated values. Recitation of a range inherently includes all sub-ranges and individual values within that range. All exemplary materials, temperatures, and dimensions may be interchanged with other functionally equivalent counterparts unless contradicted by express language. The scope of the invention should therefore be construed in light of the appended claims, with these passages serving only to illustrate representative but non-limiting embodiments.

### DESCRIPTION OF DRAWINGS

The present invention provides an integrated deposit return management system that overcomes the limitations of existing recycling and deposit return schemes through a comprehensive platform architecture combining enterprise-level configuration capabilities, consumer-facing engagement tools, and extensible connectivity with external systems. Unlike prior art systems that operate within fixed deposit structures established by regional regulatory authorities, the present invention enables stakeholders to design, deploy, and manage customized deposit return schemes with granular control over deposit values, stakeholder allocations, and operational parameters. This flexibility addresses the fundamental challenge of jurisdictional fragmentation that has historically impeded the widespread adoption and optimal performance of deposit return systems.

The invention addresses the technological deficiencies of conventional deposit return systems by providing a unified digital platform that integrates all aspects of deposit tracking, user engagement, and operational management. Where existing systems rely predominantly on physical infrastructure such as reverse vending machines and manual collection centers without meaningful digital integration, the present invention establishes a central processing system that maintains comprehensive records of container identification data, user account data, deposit configuration data, and transaction records. This centralized data architecture enables real-time tracking of containers throughout their lifecycle, from point of purchase through redemption, providing visibility and accountability that is not achievable with fragmented legacy systems.

The enterprise application module of the present invention empowers manufacturers, deposit system operators, and governmental authorities with configuration tools that have been absent from prior art systems. The deposit configuration interface enables stakeholders to define deposit structures that precisely reflect the commercial relationships and regulatory requirements of their specific jurisdictions, including the allocation of deposit value portions among multiple stakeholder entities such as consumers, retailers, manufacturers, distributors, and cooperative organizations. This configurability eliminates the need for manufacturers operating across multiple territories to develop and maintain separate systems for each jurisdiction, instead enabling unified management through a single platform with jurisdiction-specific configurations.

The consumer application module addresses the limited user engagement capabilities of existing systems by providing consumers with comprehensive tools for tracking deposits, managing account balances, and participating in the deposit return process through their personal computing devices. The identifier recognition component enables consumers to capture identifier data from containers using the cameras and sensors of their smartphones or other devices, creating a direct connection between individual containers and user accounts that facilitates accurate deposit tracking and redemption. This consumer-centric approach transforms the deposit return experience from a purely transactional interaction into an ongoing engagement that fosters sustained participation in recycling behaviors.

The partner application programming interface of the present invention addresses the interoperability challenges that have limited the scalability of prior art systems by providing a standardized mechanism for data exchange with external systems including point of sale systems, return processing devices, and recycling facility management systems. This extensible architecture enables the deposit return management system to integrate with existing retail and recycling infrastructure without requiring wholesale replacement of legacy equipment, thereby reducing barriers to adoption and enabling gradual system expansion. The partner application programming interface further enables the system to accommodate future technological developments and integration requirements that cannot be anticipated at the time of initial deployment.

The invention addresses the significant fraud vulnerabilities of conventional deposit return systems through integrated fraud detection capabilities that monitor transaction patterns and identify anomalous activities in real time. Unlike the reactive fraud detection mechanisms of prior art systems that rely on periodic audits or obvious violations, the present invention enables proactive identification of suspicious patterns such as duplicate container scans, unusual redemption rates, and geographic inconsistencies that may indicate counterfeit labels, duplicated receipts, or cross-border arbitrage schemes. This enhanced fraud prevention capability protects the financial integrity of the deposit return system and maintains stakeholder confidence in the viability of the program.

The present invention further addresses the compliance burden faced by manufacturers subject to extended producer responsibility regulations by providing comprehensive tracking and reporting capabilities through the enterprise application module. Stakeholders can monitor material flows, track recycling rates, and generate compliance reports across multiple jurisdictions through a unified dashboard interface, eliminating the need for manual data aggregation from disparate sources and reducing the administrative overhead associated with regulatory compliance. The system maintains detailed records of all transactions and material movements, providing an auditable trail that supports verification of compliance claims by regulatory authorities.

The following detailed description presents various embodiments of the invention with reference to the accompanying drawings. The described embodiments are illustrative and are not intended to limit the scope of the invention, which is defined by the appended claims. Those skilled in the art will recognize that modifications and variations of the described embodiments are possible without departing from the spirit and scope of the invention, and that the specific implementation details presented herein represent examples of how the invention may be realized in practice.

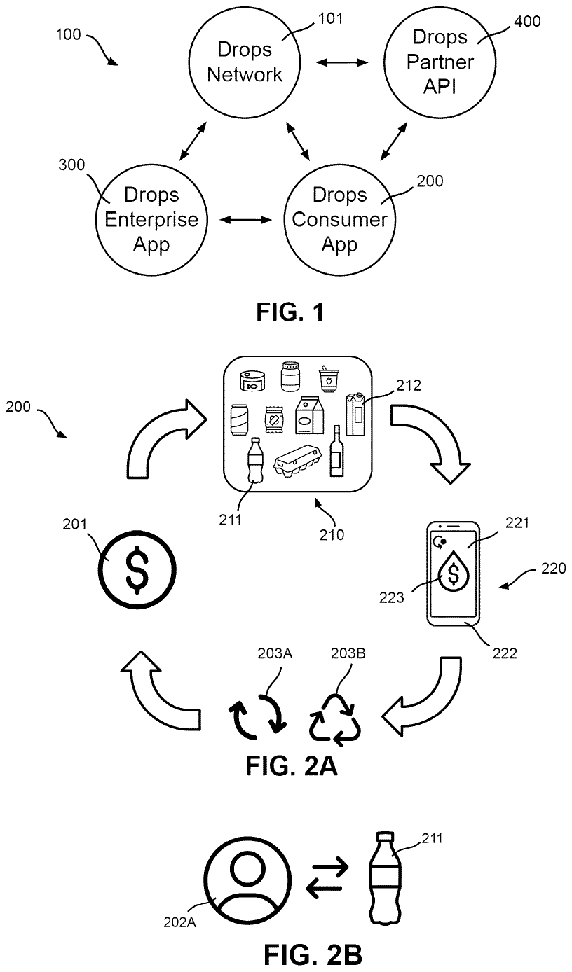

Referring now to FIG. 1, there is illustrated an architectural overview of the deposit return management system 100 in accordance with an embodiment of the present invention. The system 100 comprises a central processing system, referred to herein as the network 101, which serves as the central data and communication hub for the deposit return management system 100. The network 101 is in communication with a consumer application module 200, an enterprise application module 300, and a partner application programming interface 400, enabling coordinated operation and data exchange among the various components of the system 100.

The network 101 comprises at least one processor and at least one memory configured to manage data communications and transaction processing across the deposit return management system 100. The network 101 facilitates real-time data exchange and synchronization between the enterprise application module 300, the consumer application module 200, and external systems connected via the partner application programming interface 400. The network 101 is further configured to manage and process transactions, deposit credits, user data, and system-wide configurations. A database in communication with the network 101 stores container identification data, user account data, deposit configuration data, and transaction records as described in greater detail below. The network 101 implements appropriate security protocols to ensure data integrity and protection across the platform.

The consumer application module 200 comprises a user-facing application configured to operate on a user computing device, enabling consumers to interact with the deposit return management system 100. The consumer application module 200 is in communication with the network 101 and includes a user account component configured to maintain data relating to a user account including a deposit balance. Through the consumer application module 200, consumers may track their deposit credit balances, view transaction histories, and redeem deposit credits for financial incentives or other rewards. The consumer application module 200 may further provide gamification features and environmental impact tracking to enhance user engagement, as described in greater detail with reference to subsequent figures. The consumer application module 200 receives data from the network 101 to display accurate, real-time information about recycling activities and deposit balances to the user.

The enterprise application module 300 is designed for use by organizational stakeholders including governmental entities, manufacturers, distributors, and retailers to conFIG.and deploy customized deposit return schemes. The enterprise application module 300 is in communication with the network 101 and comprises a deposit configuration interface configured to receive input defining a deposit structure, wherein the deposit structure comprises at least a deposit value and an allocation of portions of the deposit value among a plurality of stakeholder entities. The enterprise application module 300 further provides tools for managing system settings, assigning deposit values to various container types, and monitoring performance metrics. Administrative dashboards within the enterprise application module 300 enable tracking of operational metrics, regulatory compliance status, and user engagement statistics. The enterprise application module 300 communicates directly with the network 101 to upload configurations and synchronize data with other system components.

The partner application programming interface 400 connects the deposit return management system 100 to external systems including recycling collection units such as reverse vending machines, point of sale systems, and other third-party applications. The partner application programming interface 400 enables seamless integration of the deposit return management system 100 with external hardware and software systems for deposit activation, container tracking, and redemption processes. The partner application programming interface 400 supports interoperability and scalability by enabling custom integrations tailored to the specific requirements of various stakeholders and operational contexts.

As illustrated in FIG. 1, the architecture of the deposit return management system 100 is modular and scalable in nature. By centralizing communication through the network 101 and enabling flexibility through the partner application programming interface 400, the system 100 supports diverse use cases including customized deposit return scheme configurations, consumer engagement applications, and third-party integration with external systems. This architecture enables the deposit return management system 100 to operate as a comprehensive solution for deposit return schemes and recycling incentive programs across multiple regions, jurisdictions, and industries.

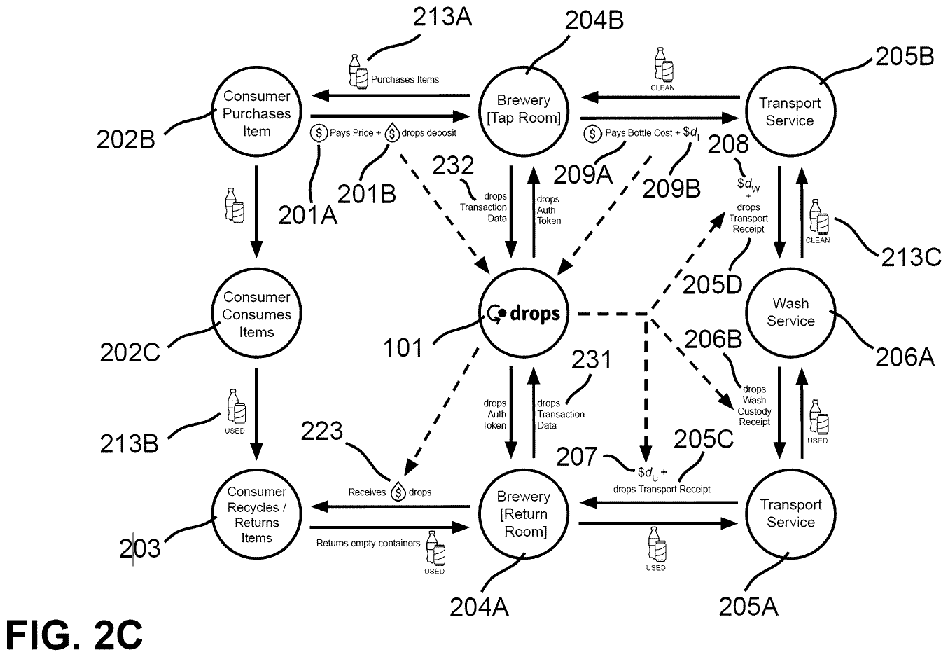

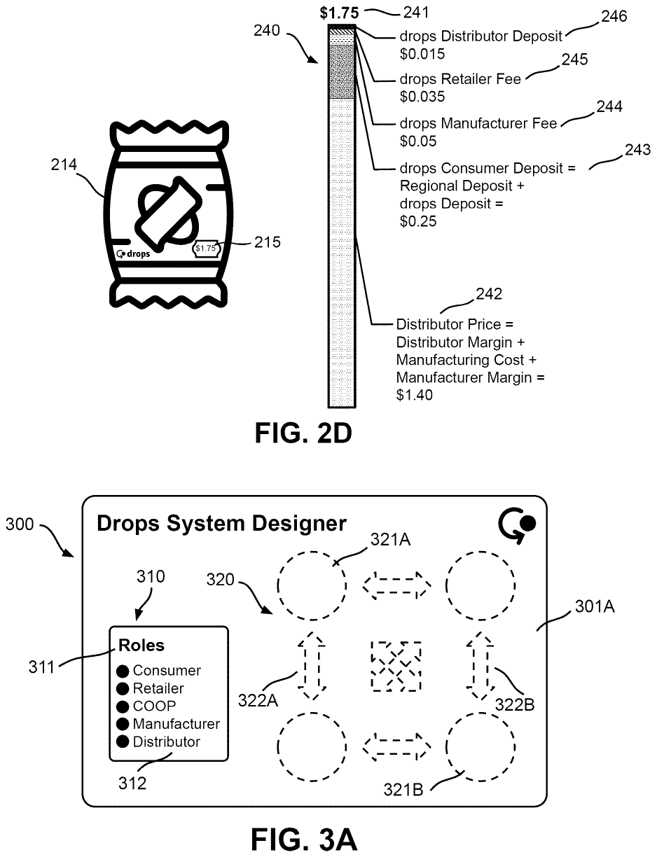

Referring now to FIG. 2A, there is illustrated a general process flow of the deposit return management system 100, showing the lifecycle of a recyclable or reusable container from purchase to deposit refund. The process flow emphasizes the consumer-focused nature of the system and the seamless integration of the consumer application module 200 with recycling and reuse processes.

The lifecycle begins with a deposit payment step 201, wherein the consumer pays a deposit included in the purchase price of a product at the point of sale or shortly thereafter. The deposit represents the value of the container's recyclability or reusability within the deposit return management system 100. In the product purchase step 210, the consumer purchases a product 211 containing a recyclable or reusable container such as a bottle, carton, can, or other eligible item. Upon purchase, the product 211 is registered in the deposit return management system 100, and a deposit potential is created within the consumer's user account.

Following the purchase, a deposit creation step 220 occurs wherein the corresponding deposit is converted into a deposit potential within the consumer application module 200. The consumer application module 200, operating on a user computing device 222, enables the consumer to track the value of their deposits, view their balance, and prepare for deposit redemption. The consumer application module 200 displays this information through a user interface 223 that provides real-time visibility into the consumer's deposit status.

The lifecycle continues with a reuse or recycle step, wherein the consumer either reuses or recycles the container by returning it to an eligible location such as a recycling center or designated drop-off point. In the illustrated embodiment, recycling is represented by reference numeral 203B while reuse processes are indicated by reference numeral 203A, highlighting the flexibility of the system in accommodating various sustainable disposal options.

The lifecycle concludes with a deposit refund step 201, wherein upon returning the container, the consumer redeems the deposit value via the consumer application module 200 or directly through a participating location. When the consumer application module 200 is utilized, the deposit potential is converted into a redeemable deposit which can be exchanged for its monetary value. The initial deposit may be refunded to the consumer in the form of financial credits, digital wallet balance, or other incentives as configured within the deposit return management system 100.

Referring now to FIG. 2B, there is illustrated the fundamental capability of the deposit return management system 100 to associate a unique user 202A with a specific product 211. This association is achieved through the system's ability to recognize and track uniquely identifiable products, enabling personalized interactions, deposit tracking, and lifecycle management.

The user 202A represents an individual participating in the deposit return management system 100. Each user 202A has a unique profile within the consumer application module 200 or associated system components, enabling personalized tracking and deposit management. The product 211 depicts a recyclable or reusable product such as a beverage container which can be uniquely identified through machine-readable identifiers such as QR codes, barcodes, or other scannable markers. These identifiers store product-specific information including the deposit value, material type, and origin of the product 211.

As illustrated by the bidirectional arrows between the user 202A and the product 211, a mutual relationship is established by the deposit return management system 100. When a user 202A purchases or scans the product 211, the central processing system links the product's unique identifier to the user's account, thereby enabling accurate tracking of deposits, lifecycle management for the product 211, and appropriate allocation of incentives for recycling or reuse activities. This association between users and uniquely identifiable products is central to the operation of the deposit return management system 100, enabling personalized user experiences, accurate tracking, and transparency throughout the recycling and reuse lifecycle.

Referring now to FIG. 2C, there is illustrated an example implementation of the deposit return management system 100 within a circular reuse model for beverage containers in a brewery setting. In this embodiment, the brewery serves as the distributor, retailer, and return point, demonstrating the flexibility of the system in accommodating vertically integrated stakeholder configurations. The process incorporates automated payment mechanisms, financial incentives, and stakeholder interactions with emphasis on the reuse and washing of containers.

The process begins when a consumer 202B purchases a beverage item 213A from a brewery tap room 204B or similar retail outlet. Payment includes the beverage price and a deposit amount 201B, which is processed via the network 101 and tracked digitally as part of the item's lifecycle. Following consumption, the consumer 202C transitions the container to a used state 213B. The consumer may then return the used container to the brewery's return room 204A or a designated drop-off location as indicated by reference numeral 203. Upon return, the consumer receives their deposit refund in the form of deposit credits 223 via the consumer application module 200 or other integrated systems.

The illustrated embodiment incorporates several financial components that facilitate the circular reuse model. A initiation fee 209B may be paid by the brewery when purchasing either new or cleaned bottles for refilling. This fee may include the cost of the bottle itself, handling fees, and system-wide operational costs, and is processed via the network 101 and tracked as part of the lifecycle of each container. When the brewery collects used containers from its return room 204A, it may receive a used item deposit credit 208 for each returned container. The used item deposit credit 208 may offset the cost of cleaned bottles the brewery purchases for reuse, providing a financial incentive for participation in the circular reuse process. Additionally, the brewery may pay a washing payment 206B to a wash service 206A for each bottle cleaned and returned, compensating the wash service for operational costs.

Transport services 205A and 205B facilitate the movement of containers within the circular reuse system. Transport service 205A transfers used containers from the brewery's return room 204A to the wash service 206A, while transport service 205B delivers clean containers back to the brewery. Transport receipts 205C and 205D may be issued and processed to ensure accountability for the movement of containers throughout the system.

The network 101 manages all transaction data and authorization within the circular reuse system. Each transaction including deposits, returns, and payments is logged and authorized via the network 101, which tracks the lifecycle of every container to ensure transparency and compliance with deposit return and reuse protocols. The system may utilize automated payment mechanisms to trigger payments and operational events, such as issuing used item deposit credits when containers are collected and processing washing payments upon confirmation of cleaning services. Digital receipts including wash custody receipts and transport receipts are generated by the system to provide accountability for each stage of the container's lifecycle.

Referring now to FIG. 2D, there is illustrated an example cost structure for a product 214, demonstrating how various financial components and deposits can be configured using the enterprise application module 300. The illustrated breakdown highlights the contributions of different stakeholder entities including consumers, distributors, retailers, and manufacturers, as well as the integration of deposit amounts into the overall product price.

The product 214 represents an item eligible for the deposit return management system 100, such as a recyclable or reusable container. A price display 215 shows the total cost of the product 214 to the consumer, which in the illustrated example is one dollar and seventy-five cents. This price includes both the consumer deposit and the product price components.

A cost breakdown 240 illustrates the allocation of the total price among various components. A distributor price 242 represents the base price of the product 214, which includes the distributor margin, manufacturing costs, and manufacturer margin. In the illustrated example, the distributor price 242 is one dollar and forty cents, forming the majority of the product's cost. A consumer deposit 243 comprises the sum of the regional deposit if applicable and the system deposit. In the illustrated example, the total consumer deposit 243 is twenty-five cents, which is refundable upon return or recycling of the product 214.

Additional fee allocations are illustrated within the cost breakdown 240. A manufacturer fee 244 of five cents is included to account for the manufacturer's contribution to the system, such as funding sustainability efforts or system maintenance. A retailer fee 245 of three and one-half cents is allocated to the retailer, compensating them for their role in facilitating the system including managing deposits at the point of sale. A distributor deposit 246 of one and one-half cents is included for the distributor, which may be refundable when the product 214 is returned through the deposit return management system 100.

The deposit structure thus comprises two distinct categories of financial components. The consumer deposit 243 represents the refundable amount payable by and returnable to the consumer upon recycling or return of the product 214, and is not allocated among other stakeholder entities. In contrast, the stakeholder fees and deposits, including one or more of the manufacturer fee 244, the retailer fee 245, and the distributor deposit 246, represent additional financial components that are allocated among the plurality of stakeholder entities and may be integrated into the overall product price. These stakeholder fees and deposits may be invisible to the consumer and function as contributions built into the product price to fund system operations, incentivize participation, or satisfy regulatory requirements. In some embodiments, the consumer deposit 243 may itself comprise multiple components, such as a regional deposit mandated by local regulations and a supplemental system deposit, wherein the total consumer deposit remains within any applicable regulatory limits. The deposit configuration interface enables configuration of both the consumer deposit and the allocation of stakeholder fees and deposits independently, providing flexibility to accommodate varying jurisdictional requirements and business arrangements.

The cost structure illustrated in FIG. 2D is fully customizable using the deposit configuration interface of the enterprise application module 300. This configurability enables manufacturers, retailers, and other stakeholder entities to adjust fees, deposits, and margins to accommodate regional laws, economic conditions, and business requirements. Each component of the price breakdown may be adjusted dynamically depending on the product type, distribution network, and recycling infrastructure. The deposit configuration interface ensures transparency by clearly defining the roles and contributions of each stakeholder entity within the deposit structure. Retailers may incorporate the configured price breakdown into their point of sale systems, ensuring accurate collection and tracking of deposits throughout the transaction process.

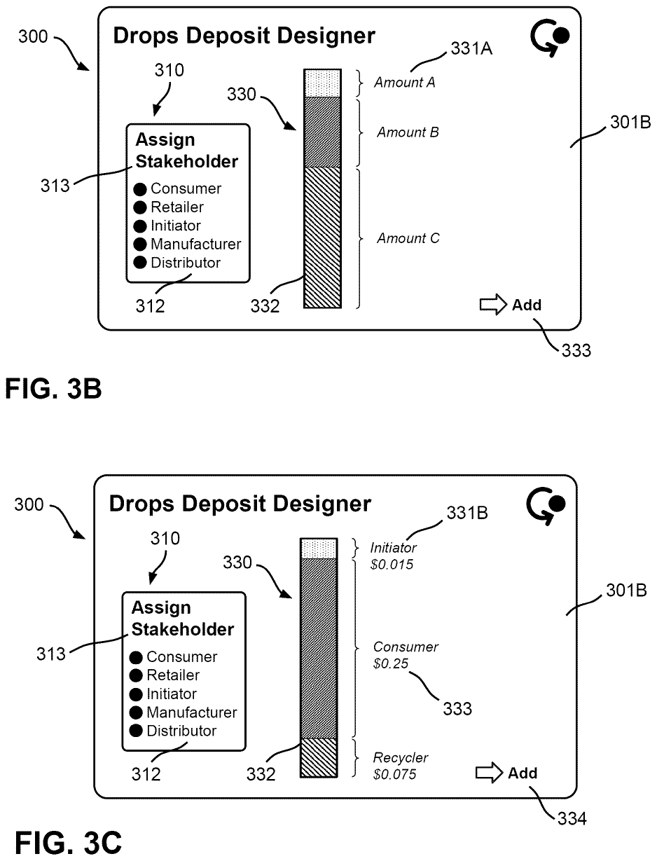

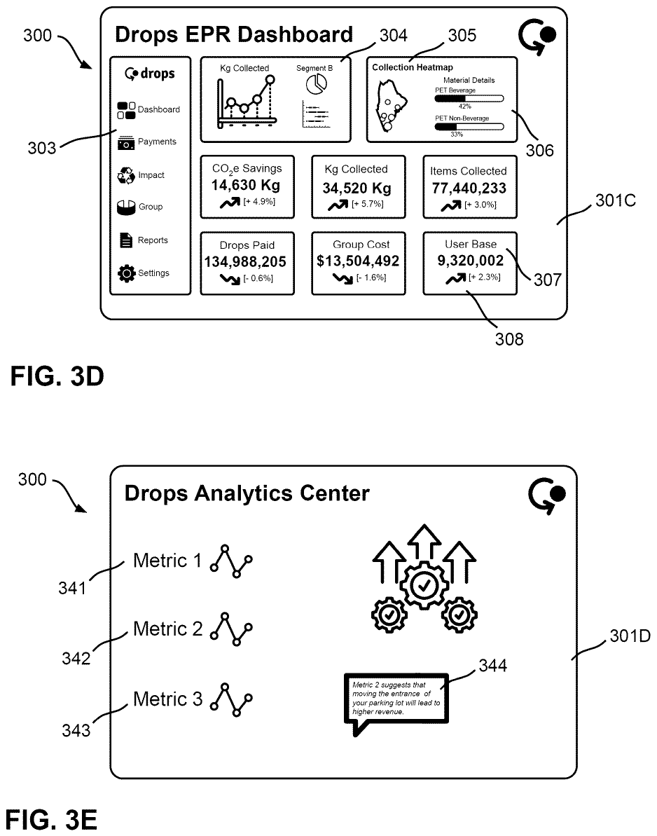

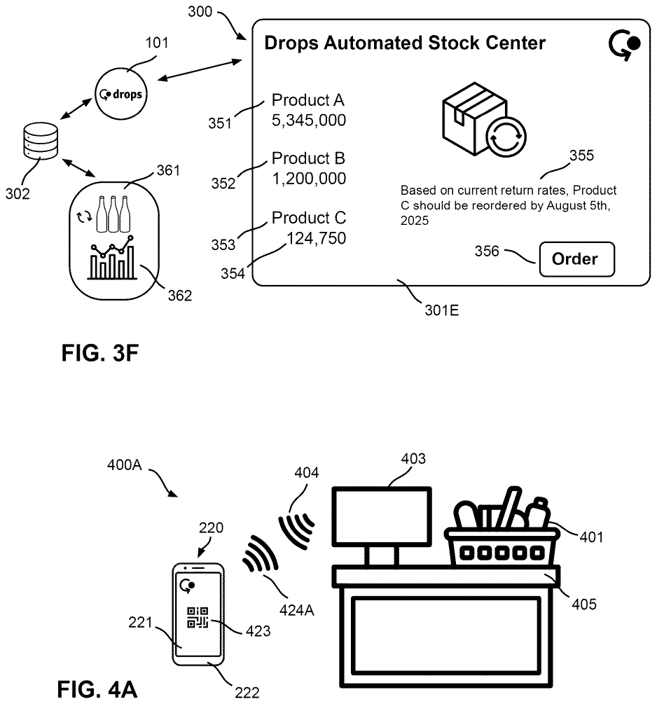

Referring now to FIG. 3A, there is illustrated a system design interface of the enterprise application module 300, which enables stakeholders to design, customize, and deploy deposit return systems. The system design interface provides a modular and expandable framework for incorporating various stakeholder entities, relationships, and operational workflows, forming a central component of the enterprise application module 300.

The system design interface comprises a roles panel 311 that lists primary stakeholder categories available for inclusion in a deposit return system configuration. In the illustrated embodiment, the roles panel 311 includes stakeholder categories such as consumer, retailer, cooperative organization, manufacturer, and distributor. The roles panel 311 is customizable, enabling users to add or modify stakeholder roles depending on the specific requirements of the deposit return system being configured. Additional roles such as transport service providers or wash facilities may be integrated into the system as needed to accommodate complex operational requirements.

A system workspace 301A provides a visual configuration environment wherein users can map relationships between stakeholder entities. The system workspace 301A displays configurable stakeholder nodes 321A and 321B represented as graphical elements that may correspond to individual entities or groups of entities within the deposit return system. Relationship indicators 322A and 322B are displayed as connectors between the stakeholder nodes, representing operational relationships such as product flows, deposit transfers, or data sharing arrangements between stakeholder entities. A central component 320 may represent regulatory oversight, centralized deposit funds, or operational control points that integrate and manage interactions among the various stakeholder entities.

Users of the system design interface can define connections between stakeholder entities through interaction with the system workspace 301A, such as through drag-and-drop actions or other input mechanisms. These connections may represent financial relationships, logistical arrangements, or operational workflows. For example, users may link retailer entities to consumer entities for deposit collection and refund processing, connect manufacturer entities to distributor entities for supply chain workflows, or add cooperative entities to manage container returns across multiple stakeholder entities. The modular design of the system design interface enables additional stakeholder categories or roles to be added to accommodate complex systems or regional requirements as they evolve.

The configured deposit return system communicates directly with the network 101, enabling real-time data exchange and seamless implementation of the designed workflows. This integration ensures that the stakeholder relationships and operational parameters defined within the system design interface are reflected in the actual operation of the deposit return management system 100.

Referring now to FIG. 3B, there is illustrated a deposit configuration interface of the enterprise application module 300, which enables stakeholders to conFIG.the financial breakdown of product deposits. The deposit configuration interface provides a modular interface for assigning deposit amounts to different stakeholder entities and defining the financial structure of the deposit return system.

The deposit configuration interface comprises a roles assignment panel 313 located on one side of the interface, which lists stakeholder categories available for deposit allocation. In the illustrated embodiment, the roles assignment panel 313 includes stakeholder categories such as consumer, retailer, initiator, manufacturer, and distributor. Users can assign deposit values to these stakeholder roles by selecting them from the roles assignment panel 313.

A configurable deposit breakdown display 330 is presented as a visual element representing the total deposit amount for a product. The configurable deposit breakdown display 330 is visually divided into segments corresponding to allocations among stakeholder entities. A first amount segment 331A represents a portion assigned to one stakeholder entity such as a retailer. Additional amount segments represent portions allocated to other stakeholder entities such as a manufacturer or the refundable consumer deposit. These segments can be adjusted dynamically to reflect different financial structures as required by regional regulations, operational needs, or business objectives.

A workspace area 301B provides a clear visual representation of the deposit breakdown, enabling users to observe how deposit amounts are distributed among stakeholder entities in real-time as adjustments are made. An add functionality element 333 enables users to introduce new stakeholder entities or roles to the deposit breakdown, supporting flexibility and scalability for customized configurations in complex deposit return systems.

The deposit configuration interface enables users to define how the total deposit amount is allocated among stakeholder entities. For example, a deposit of twenty-five cents might allocate five cents to a manufacturer for sustainability initiatives, two cents to a retailer for handling fees, and eighteen cents as the refundable consumer deposit. The modular design of the deposit configuration interface allows real-time changes to deposit structures, ensuring the system remains adaptable to shifting legal or economic conditions across different regions with varying deposit return system requirements.

Referring now to FIG. 3C, there is illustrated the deposit configuration interface of the enterprise application module 300 in a further stage of configuration wherein specific amounts have been allocated to stakeholder entities. This FIG. demonstrates how the configurable deposit breakdown display 330 appears after stakeholder entities have been assigned their respective deposit portions.

The roles assignment panel 313 continues to display the available stakeholder categories including consumer, retailer, initiator, manufacturer, and distributor. In the illustrated configuration, specific stakeholder entities have been selected and assigned deposit amounts. The configurable deposit breakdown display 330 is now partially filled, representing the assigned amounts to the selected stakeholder entities.

In the illustrated example, an initiator allocation 331B of one and one-half cents is assigned to support operational management or system-wide costs. A consumer allocation 333 of twenty-five cents is assigned as the refundable portion of the deposit. A recycler allocation is assigned at seven and one-half cents for handling and processing returned containers. The workspace area 301B provides an updated visual representation of the deposit breakdown showing the exact amounts allocated to each stakeholder entity.

An add functionality element 334 remains available to allow additional stakeholder roles or entities to be included in the deposit breakdown, maintaining scalability for more complex deposit return systems. Users can modify the assigned amounts in real-time, reflecting changes in operational costs, stakeholder requirements, or regulatory mandates. The assigned amounts directly influence financial transactions within the deposit return management system 100, ensuring that the configured deposit structure aligns with real-world operational workflows and compliance requirements.

Referring now to FIG. 3D, there is illustrated an extended producer responsibility dashboard of the enterprise application module 300, which provides a central interface for enterprise customers such as manufacturers, producer responsibility organizations, or other stakeholder entities tasked with monitoring compliance with extended producer responsibility legislation. The extended producer responsibility dashboard consolidates critical data and metrics related to recycling, collection, and sustainability efforts, offering insights tailored to the user's role and permissions within the deposit return management system 100.

A main navigation panel 303 is located on one side of the interface and enables users to access various modules within the enterprise application module 300. The navigation panel 303 provides access to a dashboard module for data visualization, a payments module for tracking financial transactions including deposits and refunds, an impact module for environmental impact metrics such as carbon dioxide savings, a group management module for managing stakeholder groups such as cooperatives or regional entities, a reports module for generating detailed compliance and performance reports, and a settings module for configuring user permissions, data views, and operational parameters.

A key metrics display area 304 presents a series of panels with real-time data segmented by relevance to extended producer responsibility compliance. The metrics display area 304 may include carbon dioxide savings data showing total carbon dioxide equivalent emissions savings with percentage changes reflecting recent performance. A materials collected metric tracks the weight of materials collected for recycling or reuse with trends over time. An items collected metric counts the total number of items returned and processed with percentage growth indicators. A deposits paid metric reflects the total deposits refunded to consumers or participants in the system with trend indicators. A group cost metric displays operational costs for stakeholder groups such as producer responsibility organizations or manufacturers with cost reduction trends. A user base metric indicates the total number of active users participating in the system with growth trend indicators.

A data visualizations area 305 includes graphical representations of key performance metrics such as line charts showing collection trends over time for specific material categories or geographic segments. A collection heatmap 306 displays regional data on collection performance including material type breakdowns and regional percentage distributions. A workspace area 301C consolidates all data views and charts, providing an interactive interface for real-time monitoring and analysis of extended producer responsibility compliance metrics.

The extended producer responsibility dashboard enables enterprise customers to track and report on compliance with extended producer responsibility legislation by monitoring the collection and recycling of mandated materials. The dashboard provides transparency for audits and regulatory submissions while facilitating data-driven decision-making through presentation of trends in key operational areas such as collection efficiency, environmental impact, and user participation. Users can conFIG.the dashboard to display data most relevant to their operations, such as metrics specific to particular materials, regions, or stakeholder groups.

Referring now to FIG. 3E, there is illustrated an analytics module of the enterprise application module 300, which provides performance benchmarking capabilities for collection facilities within the deposit return management system 100. The analytics module employs data analysis techniques to benchmark performance metrics for recycling centers, offering actionable insights and suggestions for operational improvements.

A metrics display area presents critical performance metrics for collection facilities, visually represented as graphical elements such as line graphs. A first metric display 341 may represent total material processed over time. A second metric display 342 may represent efficiency of container sorting or return throughput. A third metric display 343 may represent customer satisfaction ratings or wait times. These metrics are generated and monitored by the analytics module, enabling collection facilities to track their performance trends over time.

A performance visualization workspace 301D provides an at-a-glance summary of key performance indicators through symbolic representations such as directional indicators to signify growth and operational efficiency, and status indicators to represent achieved benchmarks or certifications. A suggestions display 344 presents actionable insights generated by the analytics module based on analyzed operational data. These suggestions may include recommendations for adjusting site layouts to optimize traffic flow, enhancing equipment performance to increase sorting accuracy, or implementing best practices for customer service.

The analytics module benchmarks individual collection facilities against peer facilities in the network, identifying areas of underperformance or excellence. Metrics may be normalized to account for regional variations or specific challenges, enabling fair comparisons across the facility network. High-performing collection facilities may receive certifications or designations through the analytics module, serving as recognition and motivation for operational excellence. Data from the analytics module integrates with the network 101, ensuring that recommendations align with broader operational goals and compliance requirements of the deposit return management system 100.

Referring now to FIG. 3F, there is illustrated an inventory management module of the enterprise application module 300, which is designed to optimize inventory management for refillable and reusable products within the deposit return management system 100. The inventory management module leverages real-time metrics regarding return rates and consumption patterns to provide actionable insights for restocking and integrates with manufacturer or supplier systems for ordering operations.

The network 101 serves as the central hub facilitating real-time communication between the inventory management module, a database 302, and other system components. The network 101 processes return rate data, inventory data, and supplier connection information to generate restocking recommendations. The database 302 stores historical and real-time data on product return rates, consumption trends, and inventory levels, supplying the network 101 with data required to calculate restocking needs and timelines.

An inventory dashboard 301E provides a user interface displaying detailed overview of current inventory levels and actionable insights. The inventory dashboard 301E may display inventory data for multiple products, such as a first product 351 with a current inventory of a first quantity, a second product 352 with a current inventory of a second quantity, and a third product 353 with a current inventory of a third quantity that may be identified as low stock. The inventory dashboard 301E displays calculated restocking timelines and recommendations 355, such as a recommended reorder date based on current return rates for products approaching low inventory thresholds.

A real-time analytics display 362 visualizes return rates and inventory changes for refillable products, enabling users to monitor trends over time. Graphs and metrics are displayed for specific product categories, providing granular insights into stock flow patterns. An order management interface 356 enables users to initiate reorders directly from manufacturers or suppliers, integrating with external supplier systems via the partner application programming interface 400 to automate procurement processes and ensure timely restocking of refillable products.

The inventory management module tracks return rates of refillable and reusable products in real-time, ensuring stock levels are maintained to meet demand without overstocking. The module predicts reorder timelines based on historical data and current trends, providing real-time insights to support informed decision-making regarding procurement and stock allocation. By connecting directly to manufacturer systems through the partner application programming interface 400, the inventory management module facilitates automated reordering to ensure timely restocking while minimizing delays in the refillable product supply chain.

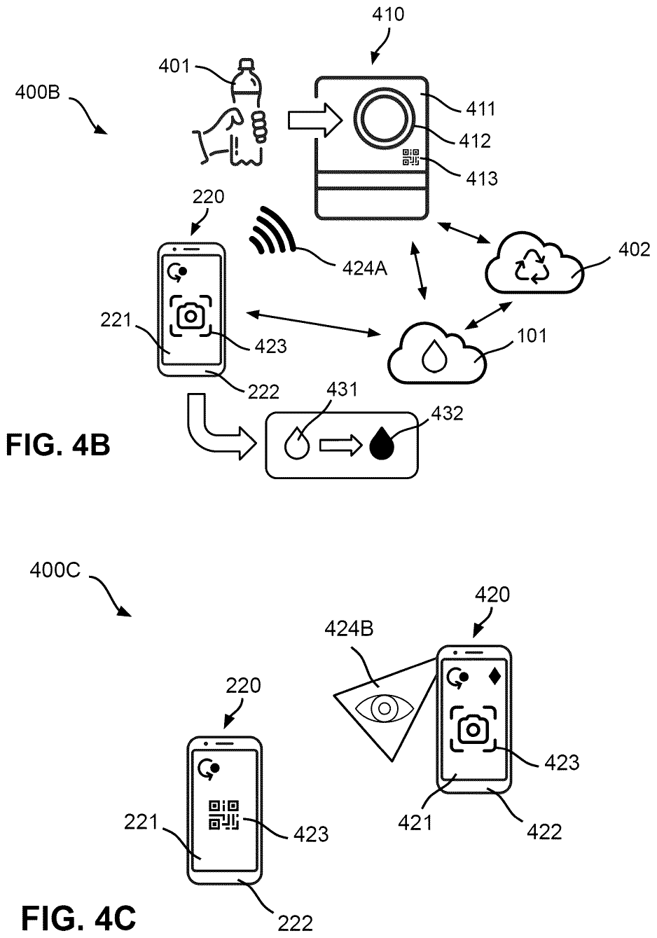

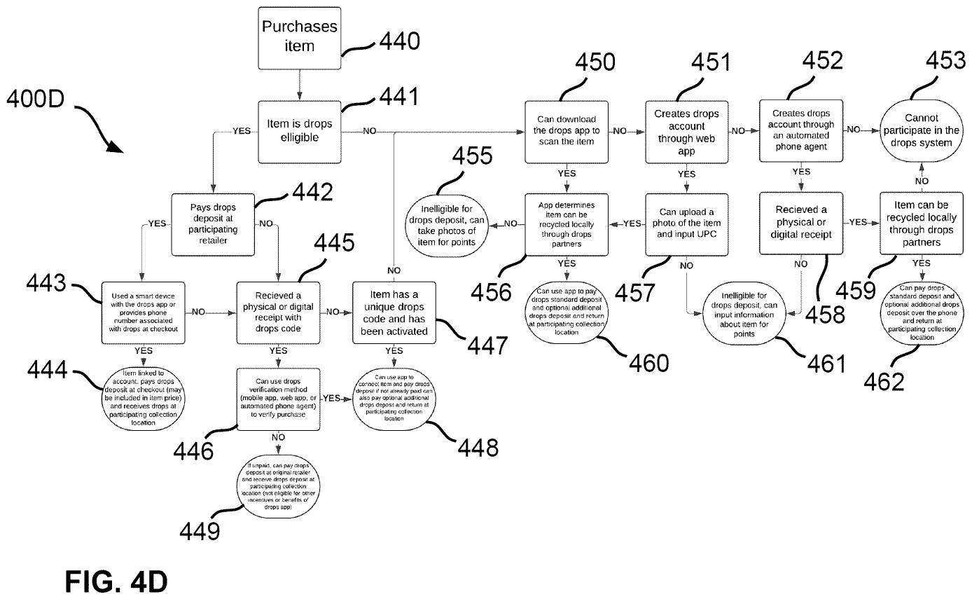

Referring now to FIG. 4A, there is illustrated the integration of a point of sale system 403 with the deposit return management system 100 during the purchase of recyclable or returnable items 401. The illustrated configuration demonstrates how the partner application programming interface 400A facilitates communication between the point of sale system 403 and the consumer application module 200 operating on a user computing device 222, enabling deposit tracking to be initiated at the time of purchase.

The recyclable or returnable items 401 represent a collection of products eligible for deposit tracking within the deposit return management system 100, such as beverage bottles, cans, or other packaging materials bearing machine-readable identifiers. The point of sale system 403 processes the transaction including product prices and associated deposit amounts. The point of sale system 403 communicates with the network 101 via the partner application programming interface 400A, which may operate through cloud-based infrastructure to ensure deposit data is synchronized in real-time with the central processing system.

The consumer application module 200 operates on the user computing device 222 and displays a scannable identifier such as a QR code 423 or other machine-readable code that enables communication with the point of sale system 403. Alternatively, communication between the user computing device 222 and the point of sale system 403 may occur via near-field communication 424A, enabling touchless interaction between the devices. The partner application programming interface 400A serves as an intermediary facilitating data exchanges between the point of sale system 403, the consumer application module 200, and the enterprise application module 300 that may be utilized by retailers or cashiers.

A checkout counter 405 represents the physical location where the point of sale system 403 is situated and where the transaction occurs. At the checkout counter 405, items are scanned, deposits are calculated, and the deposit return management system 100 is engaged to log the transaction. In embodiments where a cashier or other personnel operates the point of sale system 403, a secondary device running a version of the enterprise application module 300 may be utilized to log transactions manually, ensuring that even non-integrated point of sale systems can connect purchased items to the customer's user account within the deposit return management system 100.

The integration illustrated in FIG. 4A ensures that deposits for returnable items 401 are linked to the customer's user account at the point of purchase. This enables users to view their deposits and returnable items within the consumer application module 200 immediately following purchase. The system supports multiple communication methods including QR code scanning for devices without near-field communication capabilities and near-field communication 424A for compatible systems requiring faster touchless interactions. The connection with the network 101 ensures that transactions are logged instantly, preventing data discrepancies between the point of sale system 403 and the user account maintained within the deposit return management system 100.

Referring now to FIG. 4B, there is illustrated the process of returning a recyclable or reusable item 401 through a connected return system, demonstrating how the partner application programming interface 400B integrates with the network 101 to enable tracking, validation, and redemption of deposits. The illustrated configuration highlights the interaction between return infrastructure, the consumer application module 200, and the network 101, culminating in the conversion of a potential deposit into a redeemable deposit credit.

The recyclable or returnable item 401 represents an item such as a bottle that a user brings to a return point for recycling or reuse. A return machine system 410 comprises a physical device such as a reverse vending machine configured to accept returnable items and verify their eligibility for deposit redemption. The return machine system 410 includes a return machine 411 that accepts the returnable items, a return slot 412 where items are deposited, and a scanner 413 configured to read the item's unique identifier to log it into the system. The scanner 413 may also present a displayed or printed code that can be scanned by the user's device.

The consumer application module 200 operating on the user computing device 222 connects to the return machine system 410 via QR code scanning 423, wherein users scan the machine's displayed code to link their user account, or via near-field communication 424A for touchless connection with compatible devices. The partner application programming interface 400B facilitates integration between the return machine system 410 and the network 101, ensuring that data from the return machine system 410 is processed accurately and transmitted to the central processing system.

An external recycling network 402 may receive data about returned items from the partner application programming interface 400B, including information regarding materials recycled or reused for tracking environmental impact and regulatory compliance. The network 101 serves as the central hub for managing the lifecycle of items, deposits, and redemptions, validating the returned item's eligibility for deposit redemption and updating the user's account within the deposit return management system 100.

Upon validation of the returned item, a potential deposit 431 is converted into a redeemable deposit 432, which can be redeemed for cash or stored as credits in the user's account. The return machine system 410 scans the item and verifies its eligibility through communication with the network 101 via the partner application programming interface 400B. Once validated, the central processing system updates the user's account, converting potential deposits into redeemable credits. The partner application programming interface 400B ensures that the return process integrates with external recycling networks 402, enabling compliance with local deposit return schemes and extended producer responsibility regulations.

Referring now to FIG. 4C, there is illustrated a configuration of the partner application programming interface 400C that enables device-to-device interaction between a consumer device 220 running the consumer application module and an enterprise device 420 running a version of the enterprise application module 300. This configuration supports device-to-device communication for validating transactions, logging returns, or processing purchases within the deposit return management system 100.

The consumer device 220 comprises a user computing device 222 used by consumers to manage their user account and transactions within the deposit return management system 100. The consumer device 220 displays a scannable QR code 423 or other identifier for interaction with enterprise devices and serves as a source of information including user account details and transaction records that can be accessed or logged by enterprise devices.

The enterprise device 420 comprises a device 422 used by entities such as retailers, recycling centers, or redemption centers to perform operations within the deposit return management system 100. The enterprise device 420 runs secondary software powered by the partner application programming interface 400C to access and manage aspects of the deposit return management system 100. The enterprise device 420 includes a scanner or camera 421 configured to read the consumer device's identifier and initiate interactions.

The partner application programming interface 400C enables bidirectional communication between the consumer device 220 and the enterprise device 420, allowing the devices to exchange information dynamically and securely. The communication may occur through QR code scanning 423, wherein the enterprise device 420 reads the consumer application module's QR code or vice versa, or through near-field communication 424B for touchless secure connections. The partner application programming interface 400C facilitates real-time synchronization of data with the network 101.

The partner application programming interface 400C enables enterprise devices 420 to run lightweight versions of the enterprise application module 300 tailored to specific operational roles such as logging transactions, verifying returns, or issuing refunds. Enterprise devices 420 can access consumer account data to log purchases or returns, verify user eligibility for deposits or credits, and initiate rewards or refunds. This configuration is applicable in various operational contexts including recycling centers for logging returned items and crediting deposits, retail locations for linking purchases to consumer accounts, and redemption centers for validating user identity and processing payouts. The partner application programming interface 400C ensures that all interactions are logged in real-time with updates transmitted to the network 101 to maintain accuracy and transparency across the deposit return management system 100.

The deposit return management system 100 supports multiple pathways for users to activate deposit returns or earn alternative credits. A participation and device-interoperability component enables users to deposit containers through collection devices having varying levels of integration with the deposit return management system 100. In some embodiments, the user deposits containers through a collection device that is fully integrated with the deposit return management system 100, such as a reverse vending machine in direct communication with the central processing system 102. In other embodiments, the user deposits containers through a collection device that is partially integrated with the deposit return management system 100, wherein the collection device communicates with the central processing system 102 through an intermediary system or with limited data exchange. In further embodiments, the user deposits containers through a collection device that is not integrated with the deposit return management system 100, such as a third-party recycling bin or municipal collection point, wherein the deposit return is validated through alternative means. In still further embodiments, the user deposits containers through a device operated by a recycling center operator or other authorized party, enabling participation in regions or contexts where automated collection devices are unavailable.

The participation and device-interoperability component is configured to receive various forms of confirmation data to validate container returns. Such confirmation data may include a device-generated code produced by a collection device upon container deposit, a transaction identifier associated with the return event, a receipt-derived identifier extracted from a receipt image using optical character recognition, an item image captured by the user or an operator device, a sensor reading from a collection device confirming container deposit, a telephony-based confirmation signal received through an automated telephony system, or a machine-to-device communication token exchanged between the collection device and the central processing system 102 or consumer application module 200. Upon receiving and validating the confirmation data, the central processing system 102 logs the transaction and issues a deposit credit, alternative credit such as loyalty points or reward credits, reward such as a digital collectible or promotional benefit, or purchase authorization enabling the user to apply the credit toward a subsequent transaction.

Referring now to FIG. 4D, there is illustrated a flowchart representing a user journey through the deposit return management system 100, detailing how users may interact with the system depending on retailer participation, item eligibility, and the user's level of access to technology. The flowchart illustrates multiple pathways for deposit redemption and point accumulation to ensure inclusivity and flexibility across diverse user populations.

The user journey begins with a purchase step 440 wherein the user purchases an item. A verification step 441 determines whether the retailer is participating in the deposit return management system 100 and whether the item is eligible for deposit tracking based on whether the manufacturer is a participating stakeholder entity that has included the item within the system.

If the retailer is participating and the item is eligible, a deposit payment step 442 occurs wherein the user pays a deposit at checkout. An account connection step 443 enables the user to connect the transaction to their user account by using a smart device or providing a phone number. A receipt step 445 occurs if the user receives a receipt, which may be physical or digital and may include a unique system code that can be used to verify the purchase.

A redemption step 444 enables users whose items are linked to their user account to redeem deposits by returning items at participating collection locations. A verification step 446 enables users to use their receipt or other verification methods via the consumer application module, a web application, or a telephone system to verify the purchase and activate their user account. A payment step 449 enables users to pay standard or additional deposits at participating retailers if deposits were not paid at the time of purchase.

For items purchased from non-participating retailers or items that cannot be verified, alternative pathways are provided. A determination step 455 identifies items that cannot be verified due to lack of proper tracking or receipt as ineligible for standard deposit treatment, though users may still capture images of items to earn alternative credits. A recycling determination step 456 enables the consumer application module to determine whether ineligible items can still be recycled locally with partner facilities. Steps 457 through 460 enable users to upload photographs or input product details such as universal product codes via the consumer application module or web application to connect items to their user account. A verification failure step 461 handles items that cannot be verified due to missing data, which are considered ineligible for standard deposits though users may still recycle them for alternative credits. A verified item step 462 enables users with verified items to pay deposits and receive refunds through the standard redemption process.

Account creation pathways are provided through multiple channels to accommodate users with varying levels of technology access. A mobile application step 450 enables users to download and install the consumer application module to create a user account. A web application step 451 enables users to create accounts through a web-based interface. An automated telephony step 452 enables an automated telephone system to assist users without internet access in creating user accounts. A non-participation step 453 acknowledges that users who do not create accounts may not participate in the deposit return management system 100 but may recycle through local programs outside the system.

The flowchart illustrated in FIG. 4D demonstrates the flexibility and inclusivity of the deposit return management system 100 in accommodating users with various levels of access to technology while maintaining security through receipt verification and item code tracking. The system provides multiple pathways for deposit redemption and verification, enabling users to participate regardless of retailer integration level or technological access.

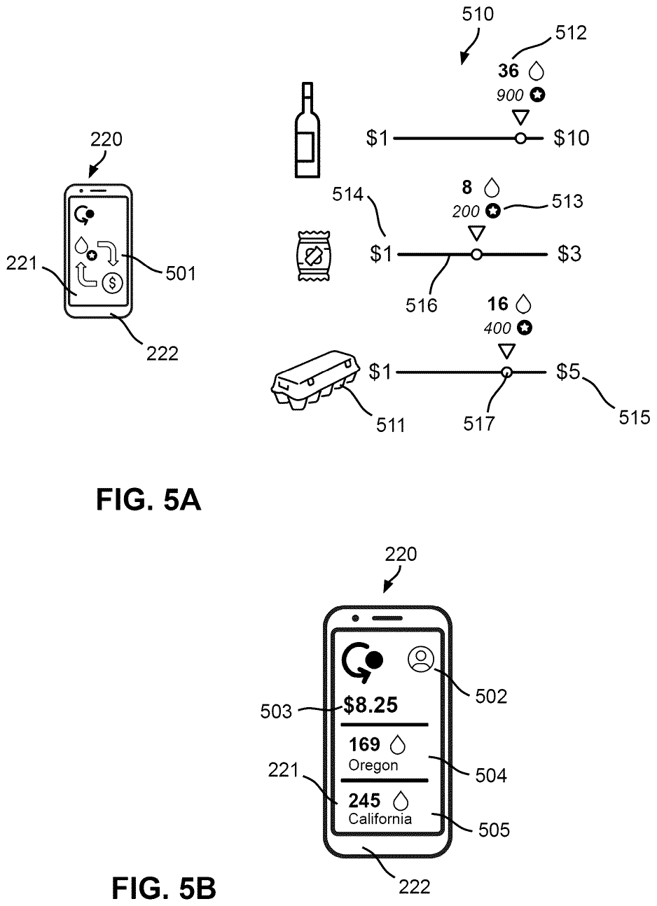

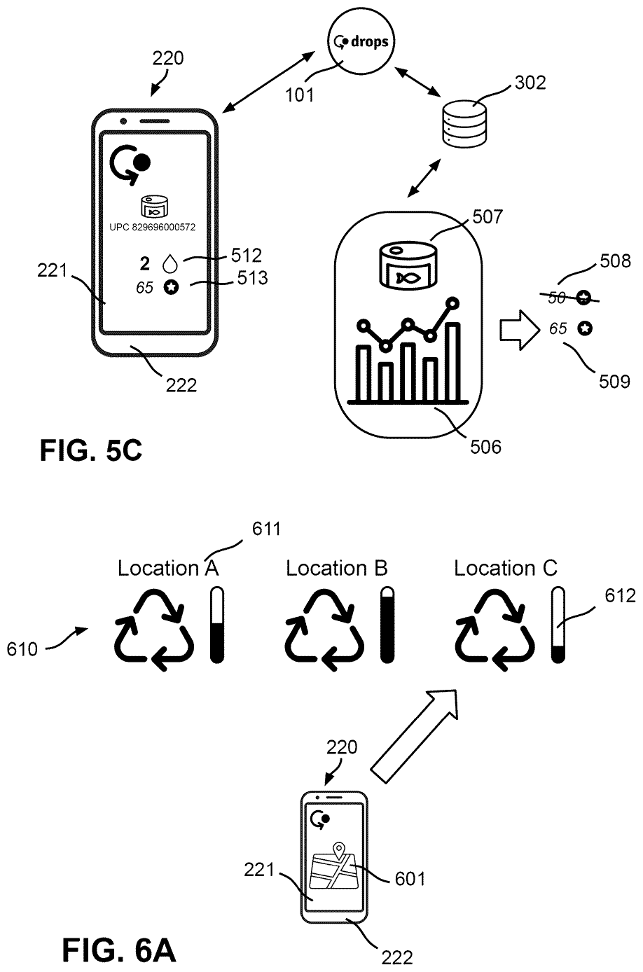

Referring now to FIG. 5A, there is illustrated a dynamic deposit adjustment component 501 of the consumer application module 200, which enables users to assign deposits to items without an existing deposit or to increase the standard deposit value for items to unlock additional incentives. The dynamic deposit adjustment component 501 operates within the consumer application module 221 on the user computing device 222 and provides an interface for managing deposits, viewing rewards, and interacting with deposit customization features.

The dynamic deposit adjustment component 501 enables users to place a custom deposit on items that typically lack a standard deposit and to increase the standard deposit on items to earn greater rewards or incentives. The interface displays interactive options for deposit customization, presenting each product with a deposit value range 510 visually represented by a horizontal indicator 511. The deposit value range 510 includes a minimum deposit value representing the lowest deposit applicable and a maximum deposit value representing the highest deposit allowed for additional incentives.

Incentive markers are displayed in association with various deposit levels within the deposit value range 510. A first incentive marker 512 indicates the number of deposit credits to be credited to the user's account for a chosen deposit level. A second incentive marker 513 indicates loyalty rewards or additional non-monetary incentives such as points redeemable for perks or benefits. A third incentive marker 514 indicates bonus rewards such as special benefits unlocked at higher deposit levels including discounts or promotional offers.

In the illustrated embodiment, multiple example products are displayed with corresponding deposit ranges and incentive structures. A first product 510 such as a wine bottle may have a deposit range of one dollar to ten dollars, with incentives of thirty-six deposit credits and nine hundred loyalty points at the maximum deposit level. A second product 511 such as a snack package may have a deposit range of one dollar to three dollars, with incentives of eight deposit credits and two hundred loyalty points at the maximum deposit level. A third product 515 such as an egg carton may have a deposit range of one dollar to five dollars, with incentives of sixteen deposit credits and four hundred loyalty points at the maximum deposit level.

Adjustable deposit selection elements 516 and 517 enable users to select their desired deposit amount using interactive markers within the deposit value range, such as draggable indicators that dynamically update the rewards display as the user adjusts the deposit level. Changes in deposit values selected by the user are logged immediately in the network 101, ensuring accurate tracking and reward calculation. The dynamic deposit adjustment component 501 facilitates seamless interaction between the consumer application module 200, retailer systems, and the broader deposit return management system 100 for synchronized deposit management.

The dynamic deposit adjustment component 501 supports multiple modes of deposit value presentation and selection. In some embodiments, the user selects a deposit value from within a predefined deposit value range as described above. In other embodiments, the dynamic deposit adjustment component 501 presents the user with a single predetermined deposit value or a set of discrete predetermined deposit values for selection. The user may actively select a presented deposit value or may automatically accept a default deposit value presented by the system.

When the user selects or accepts a deposit value that includes an additional deposit amount exceeding a base deposit value, the dynamic deposit adjustment component 501 processes the transmission of the additional funds to the central processing system 102. In some embodiments, the additional deposit amount is transmitted directly from a payment instrument associated with the user account. In other embodiments, the additional deposit amount is recorded as a deferred payment obligation associated with the user account, wherein the deferred payment obligation is satisfied through deduction from a future deposit redemption or inclusion in a subsequent purchase transaction.

In some embodiments, the dynamic deposit adjustment component 501 presents the user with options for allocation of the additional deposit amount, including depositing the additional funds into an interest-bearing account associated with the user account, enabling a matching contribution from a third party such as a manufacturer or promotional sponsor, or entering the additional deposit amount into a sweepstakes or promotional program.

Referring now to FIG. 5B, there is illustrated a regional balance component of the consumer application module 221 configured to manage region-specific deposit balances within the deposit return management system 100. The regional balance component supports interchangeability of deposits within distinct regions while maintaining separation of balances earned in different regions, accommodating users who purchase items and earn deposits across multiple jurisdictions while maintaining compliance with regional laws and policies.

The consumer application module 221 is displayed on the user computing device 222 and provides an overview of deposit balances across multiple regions through modular sections for region-specific tracking. A user profile element 502 enables users to access their account details including transaction history, regional settings, and preferences. A total wallet balance display 503 shows the wallet balance of deposits that have been redeemed for local currency, which differs from the unredeemed deposit balance maintained within the user account.

Region-specific deposit balance displays 504 and 505 present the deposit balances associated with each region in which the user has earned deposits. In the illustrated embodiment, a first regional balance display 504 corresponds to a first jurisdiction such as Oregon and displays the deposit balance earned in that jurisdiction. A second regional balance display 505 corresponds to a second jurisdiction such as California and displays the deposit balance earned in that jurisdiction. Each regional balance display lists the total number of deposit credits specific to that region, ensuring clear segregation of balances across jurisdictions.

The database of the deposit return management system 100 stores a plurality of jurisdiction identifiers, each jurisdiction identifier being associated with a respective jurisdiction-specific deposit configuration. The consumer application module 221 maintains a plurality of separate deposit balances for the user account, each deposit balance corresponding to a respective jurisdiction identifier. Deposits are fungible within the same region, meaning all deposits earned in a specific region hold the same value and can be used interchangeably for refunds or redemptions within that region. Deposits earned in one region are non-transferable to another region, maintaining compliance with regional deposit return schemes and associated regulatory requirements.

The regional balance component enables users who travel or make purchases across state or national borders to view and manage region-specific balances independently while supporting regions with distinct deposit values and redemption processes. The regional balance management functionality is connected to the network 101 to ensure real-time synchronization and updates reflecting the user's latest transactions and earned deposits across all applicable jurisdictions.

Referring now to FIG. 5C, there is illustrated a dynamic pricing module of the central processing system that adjusts the value of deposits 512 and associated rewards 513 in real-time based on data analytics. The dynamic pricing module employs an algorithm that leverages real-time data to respond to market conditions such as recycling rates, material demand, and environmental impact metrics, optimizing user incentives dynamically to encourage recycling in regions or scenarios where increased participation is most beneficial.

The consumer application module interface 221 is displayed on the user computing device 222 and provides real-time feedback on deposit and reward values to the user. In the illustrated embodiment, the consumer application module 221 identifies a product using a product identifier such as a universal product code and displays the current value of deposits 512 and associated rewards such as loyalty points 513.

The network 101 acts as the central hub for processing data and deploying the algorithm's calculations across the deposit return management system 100. The network 101 communicates with the database 302 to retrieve real-time data for market analysis. An analytics component 506 collects and analyzes data including regional recycling rates, material market demand and pricing, and environmental metrics such as carbon dioxide impact reductions. A product data component 507 displays product-specific insights and real-time adjustments including the updated value of associated deposits or rewards.

The dynamic pricing module performs incentive adjustment by recalculating the value of deposits and rewards based on the analyzed data. An initial value 508 represents the previous incentive value prior to adjustment. An updated value 509 represents the dynamically adjusted incentive reflecting current market conditions and system objectives. The algorithm adjusts values based on various factors including material shortages wherein higher demand for recycled materials increases the value of deposits, recycling goals wherein regions struggling to meet recycling targets may offer higher rewards to incentivize participation, and environmental metrics wherein high-impact materials may yield greater rewards to encourage recycling of materials with significant environmental benefits.

The updated values calculated by the dynamic pricing module are displayed within the consumer application module 200, ensuring consumers are aware of value adjustments in real time. The dynamic pricing module encourages consumers to recycle at times and locations where recycling has the greatest impact, aligning user behavior with systemic sustainability goals. The algorithm is integrated with the network 101 to ensure consistency and synchronization across all connected users and devices within the deposit return management system 100.

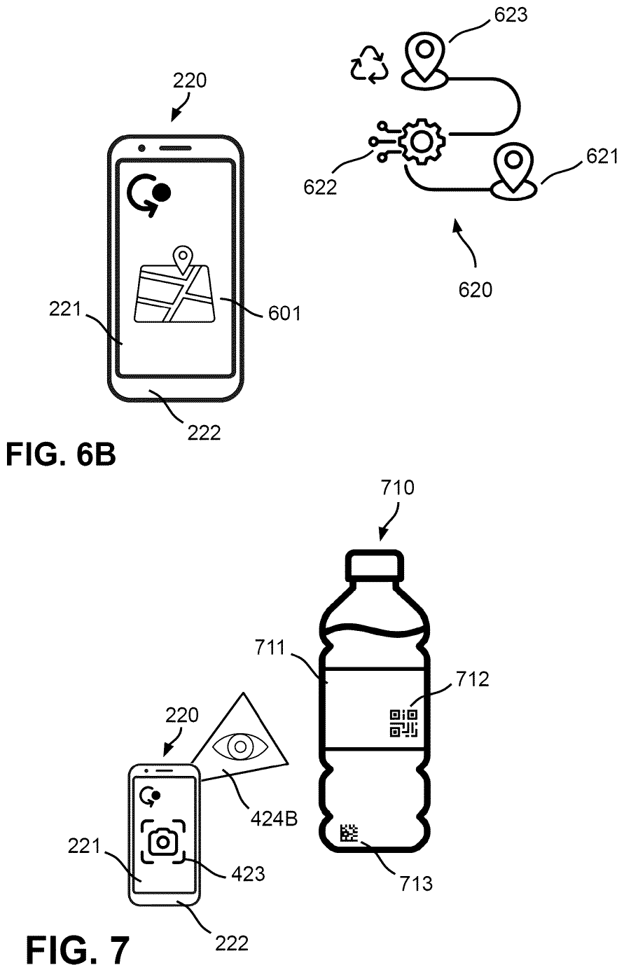

Referring now to FIG. 6A, there is illustrated a volume prediction module of the central processing system configured to optimize recycling operations through predictive analysis and load balancing across collection facilities. The volume prediction module applies a predictive model to real-time and historical data to forecast recycling volumes at various collection facility locations 610 and recommends suitable collection facilities for users based on current and predicted capacities.

A plurality of collection facility locations 610 are represented in the illustrated embodiment, including a first location A, a second location B, and a third location C. Each collection facility location has an associated capacity indicator representing current volume relative to total capacity. A first capacity indicator 611 for location A shows moderate capacity usage with a partially filled representation. A second capacity indicator for location B displays a fully filled representation indicating that the facility is nearing or at full capacity. A third capacity indicator 612 for location C shows the least utilized capacity with a low-filled representation, identifying location C as having available capacity for additional recycling volume.

The consumer application module 221 operates on the user computing device 222 and includes an interactive map module 601 that displays collection facility locations and provides visual guidance to recommended facilities. The interactive map module 601 dynamically recommends collection facilities based on current capacity at each location, proximity to the user's current location, and real-time volume processing data received from the network 101.

The volume prediction module is integrated with the network 101 and processes multiple data types to generate predictions and recommendations. Real-time data regarding current recycling volume versus capacity at each collection facility location is analyzed to determine present availability. Historical data regarding patterns of recycling traffic and behavior is processed to identify trends and predict future volumes. External factors such as seasonal trends, local events, or policies influencing recycling demand may be incorporated into the predictive model. The volume prediction module continuously updates predictions to ensure accurate recommendations are provided to users through the consumer application module 200.

The volume prediction module implements a dynamic recommendation process wherein the system identifies collection facility locations with available capacity and directs users accordingly. In the illustrated embodiment, location C with current volume indicator 612 has the lowest volume compared to its capacity, making it the optimal site for the user to recycle their items. Location B is identified as nearing or at capacity and is accordingly deprioritized in recommendations to prevent delays or inefficiencies at that facility.

The volume prediction module distributes traffic efficiently across collection facilities by directing users to underutilized locations, reducing bottlenecks and operational strain at high-volume centers. The interactive map module 601 highlights recommended collection facilities based on the analysis performed by the volume prediction module, guiding users to locations that optimize load balancing across the collection facility network while ensuring all facilities operate within optimal capacity limits.

Referring now to FIG. 6B, there is illustrated a routing optimization component 620 of the consumer application module 200, which provides environmentally efficient routing suggestions to users when traveling to collection facility drop-off points. The routing optimization component 620 employs optimization algorithms to calculate routes based on traffic conditions, distance, carbon emissions estimates, and user location history, providing personalized recommendations tailored to user travel patterns.

The consumer application module 221 operates on the user computing device 222 and includes a mapping interface 601 that provides visual directions to recommended collection facility drop-off points. The mapping interface 601 interacts with the routing optimization component 620 to display dynamically updated route suggestions based on current conditions and user preferences.

The routing optimization component 620 comprises a central algorithm that integrates multiple data sources and processing capabilities. A location data component 621 identifies user location and collection facility locations within the geographic area. A routing component 622 leverages computational techniques and real-time data to calculate efficient and environmentally favorable routes. A collection points component 623 recommends specific drop-off points based on proximity, capacity, and route efficiency considerations.

The routing optimization component 620 incorporates personalization capabilities that analyze user location history and regular travel patterns stored within the user account. Based on this analysis, the routing optimization component 620 suggests collection facility locations that align with the user's regular routines, identifying recycling opportunities that require minimal deviation from normal travel patterns. The routing optimization component 620 retrieves real-time data from the network 101 and geospatial databases to provide accurate and current recommendations.

The routing optimization component 620 calculates a plurality of route options from the user's current location to one or more collection facilities and applies an optimization algorithm based on multiple factors. Routes are optimized to reduce estimated carbon emissions by considering traffic congestion levels, fuel efficiency implications of various routes, and distance to destination. The routing optimization component 620 provides dynamic updates with real-time rerouting if traffic conditions change or collection facility capacity status changes during the user's travel, ensuring the most efficient drop-off experience is maintained throughout the journey.

In operation, a user accessing the consumer application module 221 to locate a collection facility receives recommendations from the routing optimization component 620. The routing optimization component 620 identifies the most efficient drop-off point based on proximity to other destinations the user may be visiting, current traffic conditions and available capacity at collection facilities, and estimated carbon emissions for the recommended route compared to alternative routes. The mapping interface 601 displays the optimized route, guiding the user to the recommended collection facility along a path calculated to minimize environmental impact while accommodating user convenience and collection facility capacity constraints.

Referring now to FIG. 7, there is illustrated the process by which the consumer application module 221, operating on a user computing device 222, interacts with uniquely identifiable products such as a recyclable bottle 710 to capture identifier data and associate products with the deposit return management system 100. The illustrated configuration demonstrates how the system leverages both visual scanning and encoded identification mechanisms to facilitate deposit tracking, recycling incentives, and consumer engagement.

The consumer application module 221 operates on the user computing device 222 and serves as the primary interface for user interaction with the deposit return management system 100. The consumer application module 221 includes a scanning module 423 that enables users to capture visual data using the camera or other imaging sensor of the user computing device 222. A recognition component 424B employs processing algorithms including image recognition and code decoding techniques to process captured data and identify the product. The recognition component 424B may utilize machine learning models, pattern matching algorithms, or other computational techniques to analyze visual data and extract product identification information.

The recyclable bottle 710 represents an example container bearing machine-readable identifiers configured for use with the deposit return management system 100. The recyclable bottle 710 includes a label 711 containing general branding and information about the product. A primary code 712 is disposed on the recyclable bottle 710 and comprises a visible machine-readable code such as a QR code that uniquely identifies the product batch, product type, manufacturer, or other product attributes. A secondary code 713 is disposed on a different surface of the recyclable bottle 710, such as the bottom of the container, and comprises an additional identifier such as a laser-etched code or micro-QR code for enhanced traceability.

In operation, a user initiates the scanning process via the scanning module 423 of the consumer application module 221. The scanning module 423 activates the camera or imaging sensor of the user computing device 222 and captures visual data of the product including the primary code 712, the secondary code 713, or other identifiers visible on the recyclable bottle 710. The recognition component 424B analyzes the captured visual data to decode the machine-readable identifiers, confirm the product's identity, and verify the product's eligibility for deposit tracking within the deposit return management system 100.

Upon successful identification of the product, the consumer application module 221 communicates with the network 101 to complete the association between the product and the user account. Depending on the context of the scanning operation, the product's deposit may be activated upon initial purchase, updated to reflect changes in deposit status, or redeemed upon return of the container to a collection facility. The network 101 processes the identifier data received from the consumer application module 221, retrieves corresponding container data from the database, and updates the user account to reflect the transaction.

The incorporation of both a primary code 712 and a secondary code 713 on the recyclable bottle 710 provides redundancy that ensures robust product identification even in cases where one code is damaged, obscured, or otherwise unreadable. The dual-identifier configuration enables the recognition component 424B to successfully identify the product by reading whichever code is accessible and legible during the scanning operation. The recognition component 424B may additionally process metadata encoded within the machine-readable identifiers, such as product attributes, recycling instructions, material composition, or sustainability certifications, which may be displayed to the user or utilized by the deposit return management system 100 for tracking and compliance purposes.

While FIG. 7 illustrates the scanning and identification process with reference to a recyclable bottle 710, the system is configured to accommodate various container and packaging types using similar visual and encoded identification techniques. The scanning module 423 and recognition component 424B are capable of processing multiple code formats and identifier types, enabling the deposit return management system 100 to scale across diverse product categories and packaging configurations while maintaining consistent identification accuracy and user experience.

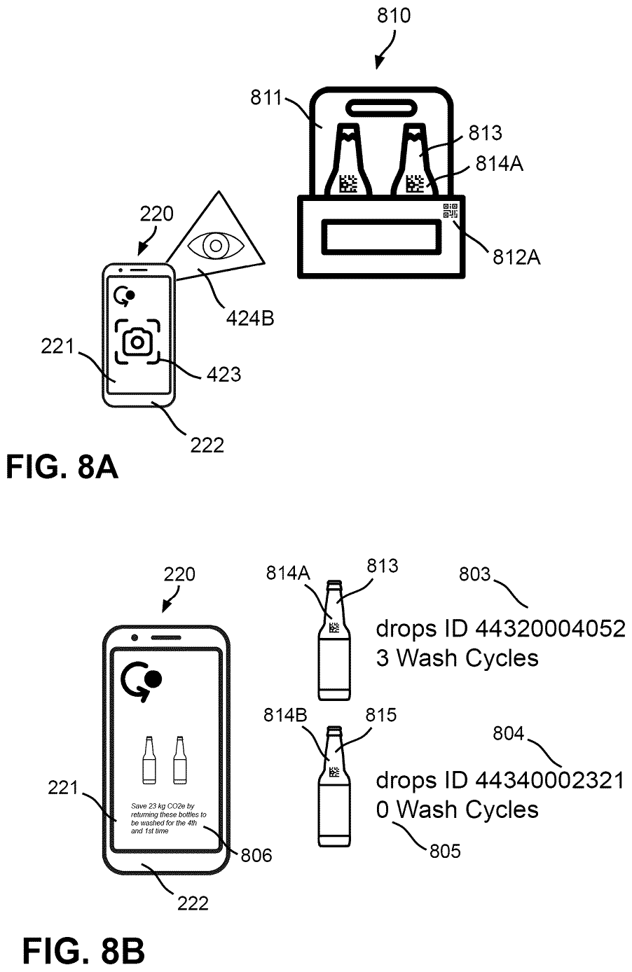

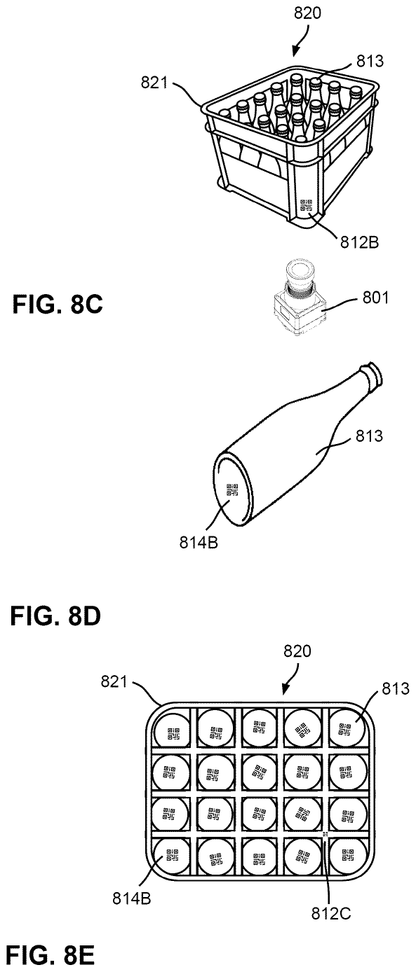

Referring now to FIG. 8A, there is illustrated the process by which the deposit return management system 100 facilitates the purchase of multi-item packaging 810 at a point of sale by associating deposits with both the outer package and the individual items contained within the package. The consumer application module 221, operating on the user computing device 222, scans a code on the package to activate deposits and associate the purchase with the user account.

The consumer application module 221 includes a scanning module 423 that enables the application to visually or digitally recognize codes on packaging using the camera or imaging sensor of the user computing device 222. A recognition component 424B utilizes processing algorithms to analyze data from scanned identifiers and extract product identification information.

The product packaging 810 comprises an outer packaging 811 configured as a case or container holding multiple individual items such as beverage bottles 813. A package code 812A is disposed on the outer packaging 811 and comprises a QR code or similar machine-readable identifier that links the package to the deposit return management system 100. Individual item identifiers 814A are disposed on each item within the package, such as unique or batch-level QR codes or other machine-readable markers on each beverage bottle 813.

In operation, a user scans the package code 812A using the consumer application module 221. The scanning module 423 captures the package code 812A and the recognition component 424B identifies the package within the network 101. If the package is configured to include unique identifiers for its contents, the central processing system can associate the individual items 813 with the package for enhanced traceability. The deposit return management system 100 activates the deposit for the package and its individual items upon purchase, and the entire transaction is recorded in the database with the deposit linked to the user account via the consumer application module 200.

The package code 812A serves as the primary identifier enabling efficient deposit activation for multiple items in a single scanning operation. The system can optionally associate the individual item identifiers 814A with the package code 812A, enabling granular tracking and individual deposit redemption for each item within the package. Users may redeem deposits for individual items 813 or for the entire package 811 depending on the configuration of the deposit return management system 100 and applicable regional regulations.

Referring now to FIG. 8B, there is illustrated the tracking and display of reuse history and environmental impact data for reusable containers within the deposit return management system 100. The consumer application module 221 displays specific data for each container including its unique identifier, the number of reuse or wash cycles completed, and corresponding environmental impact metrics such as carbon dioxide equivalent savings.

The consumer application module 221 operates on the user computing device 222 and includes a display module 806 configured to present personalized environmental benefit information to the user. The display module 806 provides users with insights into the lifecycle of their containers through reuse data visualization.

A first reusable container 813 is marked with a unique identifier 814A and tracked by the network 101. Data displayed 803 for the first container includes the unique identifier such as a system identification number and usage history indicating the number of wash cycles the container has undergone. In the illustrated embodiment, the first container 813 has completed three wash cycles. A second reusable container 815 is marked with a different unique identifier 814B. Data displayed 804 for the second container includes its unique identifier and indicates that the container has not yet undergone any reuse or wash cycles.

An environmental incentives display 806 calculates and presents the total carbon savings achievable through continued reuse of the containers. In the illustrated embodiment, the display indicates the carbon dioxide equivalent savings that would result from returning both containers for additional wash cycles. Each reusable container 813, 815 is assigned a unique identifier 814A, 814B enabling granular tracking of its reuse history within the database of the deposit return management system 100. The identifiers may comprise QR codes, radio-frequency identification tags, or other unique tagging systems.

In operation, a user scans or uploads the container information into the consumer application module 221. The consumer application module 221 retrieves data from the network 101 and displays details about each container's history and environmental impact. The consumer application module 221 informs users about the environmental benefits of returning their containers for washing and reuse, presenting containers with high reuse counts as achievements while encouraging users to initiate the reuse process for containers with no prior reuse history.

Referring now to FIG. 8C, there is illustrated a crate system 820 configured to hold multiple reusable bottles 813 and equipped with unique identification codes for tracking. The crate system 820 includes an individual crate 821 that can undergo a dedicated washing process similar to the bottles it contains. The illustrated configuration demonstrates the use of a machine vision system 801 for efficient scanning and processing of the crate and its contents.

The crate 821 comprises a durable, reusable container designed to hold multiple bottles 813 for transport, storage, or processing. The crate 821 is washable and integrated into the reuse process to ensure it meets hygiene standards alongside its contents. A crate code 812B is disposed on the crate 821 and comprises a unique identifier enabling tracking and association with the contents of the crate during processing operations.

Each bottle 813 within the crate 821 is equipped with unique identifiers such as QR codes or other machine-readable tags for individual tracking. The bottles 813 and crates 821 can be processed as an integrated system or independently depending on operational requirements. The machine vision system 801 comprises at least one imaging device positioned to scan crates from various angles including from below, ensuring all identifiers for both bottles 813 and the crate 821 are captured efficiently. The machine vision system 801 supports high-speed processing of multiple identifiers simultaneously to optimize operational throughput.

In operation, the crate system 820 containing reusable bottles is positioned within a scanning area for processing. The crate 821 can also be scanned independently when undergoing a washing process. The machine vision system 801 captures identifiers from the crate code 812B to track the crate system and from individual bottles 813 to monitor reuse cycles and deposit credit information. The central processing system ensures accurate association between the crate and its contents within the database. Captured data from bottles and crates is synchronized with the network 101, updating records regarding reuse cycles, washing status, and environmental impact metrics. Both the crate 821 and bottles 813 can be routed to washing facilities where they are cleaned as part of their reuse lifecycle, with the crate's unique identifier ensuring its status is tracked through washing and return logistics.

Referring now to FIG. 8D, there is illustrated a bottle 813 with a unique identifier code 814B disposed on the bottom surface of the container. This positioning enables the identifier to be scanned when the bottle is stored in a crate system or during processing workflows such as returns, sorting, or washing operations.

The bottom surface of the container is utilized for placing the unique identifier code 814B. This placement ensures visibility and accessibility during machine vision scanning, particularly when bottles are positioned inside crates or traveling on conveyor systems. The identifier location is compatible with machine vision systems designed to scan bottles in bulk while the bottles remain in a crate, enabling simultaneous scanning of all bottles in a crate without the need for manual handling or individual bottle manipulation.

The bottom placement of the identifier code 814B minimizes interference with the bottle's design or branding disposed on the side surfaces of the container. The placement ensures unobstructed scanning even in stacked or tightly packed arrangements and enhances operational efficiency by enabling automated bulk scanning processes. Applications of the bottom-placed identifier include return processing wherein scanning the bottom identifiers ensures that all bottles are accurately logged into the system during return operations, washing workflow tracking wherein the identifiers enable tracking of individual bottles through cleaning and reuse cycles, and inventory management wherein the identifiers facilitate efficient tracking of bottles within logistical operations.

Referring now to FIG. 8E, there is illustrated a bottom view of the crate system 820 showcasing the arrangement of bottles 813 within the crate 821. This perspective emphasizes how the unique identifiers 814B disposed on the bottom surfaces of the bottles are visible and scannable when the crate is viewed from below.

The crate 821 securely holds multiple bottles 813 in organized positions, ensuring that the identifiers on the bottle bottoms remain exposed for scanning operations. The crate system 820 is compatible with machine vision systems designed for bulk scanning during operations such as returns or inventory tracking. Each bottle 813 in the crate is aligned so that its unique identifier 814B is oriented toward the bottom of the crate, ensuring visibility for scanning systems positioned beneath the crate.

The crate 821 features open-bottom slots or cutouts 812C that provide unobstructed visibility of the identifiers on the bottles contained within the crate. The design of the cutouts 812C facilitates efficient scanning and processing without requiring removal of the bottles from the crate. Machine vision systems can scan all identifiers simultaneously in a single operation through the cutouts 812C, streamlining processes such as returns, washing workflow management, and inventory tracking while reducing the need for manual handling and improving processing speed and accuracy.

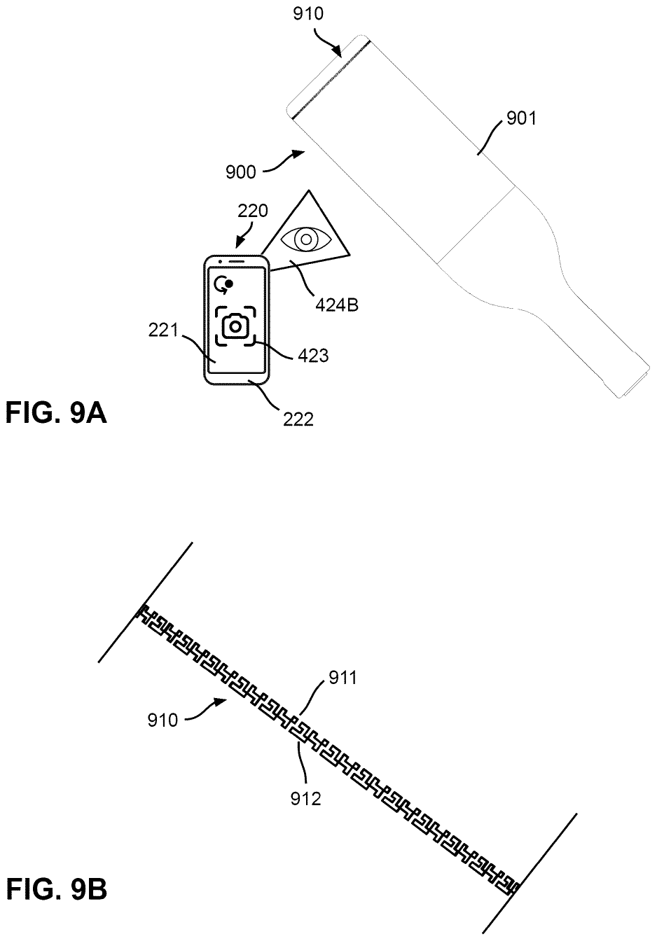

Referring now to FIG. 9A, there is illustrated an encoding methodology 900 designed for reusable containers such as a bottle 901. The methodology incorporates a circumferential code 910 comprising a repeating sequential two-dimensional code pattern disposed around the circumference of the bottle 901, enabling scanning and data retrieval regardless of the rotational orientation of the bottle.

The circumferential code 910 comprises a repeating sequential pattern that wraps around the circumference of the bottle 901. The circumferential code 910 may utilize existing code standards such as QR codes or Data Matrix codes, or may comprise a customized simplified code format designed for high readability in dynamic environments. The circumferential code 910 is applied during manufacturing of the bottle 901, ensuring permanent visibility and durability across the lifecycle of the container.

The consumer application module 221 operates on the user computing device 222 and leverages the camera 423 and an embedded computer vision module 424B to decode the circumferential code 910. For industrial applications, machine vision systems read the circumferential code 910 at high speed regardless of bottle orientation as the bottle travels on conveyor belts or through other processing equipment.

In operation, a user computing device 222 or machine vision system captures an image of the circumferential code 910. Because the code pattern repeats around the circumference of the bottle 901, at least a portion of the complete code is visible and readable from any rotational orientation of the bottle. The recognition component 424B or machine vision processing system decodes the captured code data and relays the decoded data to the network 101 to perform actions such as validation, tracking, or incentive processing.

Consumer applications of the circumferential code 910 include scanning the code with the consumer application module 221 to access information such as recycling incentives, container reuse history, or environmental impact metrics. Industrial applications include identification of bottles traveling on conveyor belts in processing facilities using machine vision systems. Retail and redemption applications include encoding bottle-specific data to facilitate deposit refund processing and inventory management operations.

The circumferential encoding methodology 900 eliminates dependency on bottle alignment during scanning, ensuring accuracy in dynamic environments where bottle orientation cannot be controlled. The encoding connects consumers directly to bottle lifecycle data through the consumer application module 200 and reduces bottlenecks in logistics and processing operations due to reliable high-speed scanning capabilities. The methodology is applicable to various container shapes and operational contexts, enabling scalability across diverse product categories and industries.

Referring now to FIG. 9B, there is illustrated in greater detail the structure of the circumferential code 910 introduced in FIG. 9A, demonstrating the arrangement of encoding components that enable orientation-independent scanning and reliable data retrieval. The circumferential code 910 comprises a repeating sequential pattern including a plurality of visual orientation markers 911 and a plurality of data elements 912 arranged between the visual orientation markers 911.

The visual orientation markers 911 comprise distinct graphical elements that serve as alignment references for scanning systems. The visual orientation markers 911 enable cameras or scanning devices to quickly determine the rotational alignment of the circumferential code 910 and to distinguish between repeated instances of the code pattern disposed around the circumference of the container. In the illustrated embodiment, the visual orientation markers 911 comprise square elements or other distinctive geometric shapes that are readily distinguishable from the data elements 912.

The data elements 912 comprise the primary encoded information within the circumferential code 910, which may include container-specific data such as unique container identifiers, product type information, manufacturer identifiers, deposit values, or other attributes relevant to the operation of the deposit return management system 100. The data elements 912 are positioned between successive visual orientation markers 911 and are carefully differentiated from the orientation markers to prevent confusion in scanning systems that read overlapping or repeated portions of the code pattern.

The repeating nature of the circumferential code 910 provides redundancy that reduces errors caused by damage, wear, or incomplete scans of the code pattern. If one portion of the circumferential code 910 is obscured or damaged, scanning systems can capture and decode an adjacent portion of the repeating pattern to successfully identify the container. The visual orientation markers 911 enable scanning systems to separate repeated instances of the code and correctly interpret the data elements 912 regardless of which portion of the circumference is captured during a scanning operation.

The circumferential code 910 may be applied to containers using various marking techniques including ink-jet printing, laser etching, or other permanent marking methods that ensure durability across the container lifecycle including multiple wash cycles for reusable containers. The encoding structure illustrated in FIG. 9B enables seamless integration across diverse operational contexts including consumer scanning using the consumer application module 200, industrial scanning using machine vision systems on conveyor lines, and retail scanning at point of sale or redemption locations.

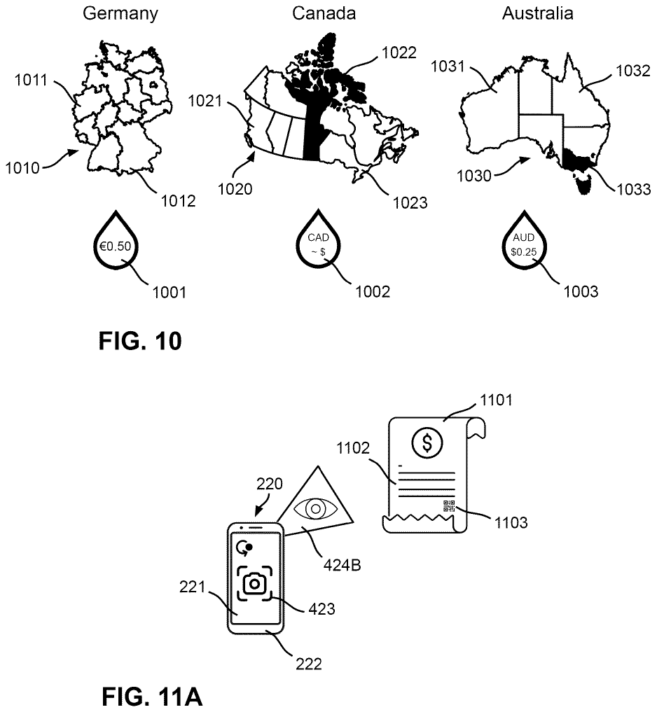

Referring now to FIG. 10, there is illustrated the capability of the deposit return management system 100 to integrate with diverse deposit return regulatory frameworks across multiple jurisdictions, demonstrating how the system adapts to national and regional variations while maintaining consistent operation. The illustrated configuration shows example implementations in Germany 1010, Canada 1020, and Australia 1030, each representing different regulatory structures for deposit return systems.

A first jurisdiction configuration 1010 represents Germany, which operates under a national deposit return system with a uniform deposit value across all states. Specific states such as a first state 1011 representing Nordrhein-Westfalen and a second state 1012 representing Bavaria are illustrated to demonstrate that deposit balances within the deposit return management system 100 are interchangeable across the country with the same deposit value. A deposit value indicator 1001 represents an example deposit value in Euros that may be configured within the enterprise application module 300, which may be set equal to or higher than the statutory national deposit value to provide enhanced incentives for recycling participation.

A second jurisdiction configuration 1020 represents Canada, which operates under regionally governed deposit return systems with varying deposit values across provinces and territories. A first province 1021 representing British Columbia operates its own deposit value system, and a second province 1022 representing Quebec operates a different deposit return system with a unique deposit value. Additional provinces and territories such as Manitoba and Nunavut lack statutory deposit systems, representing the fragmented nature of deposit return regulation in this jurisdiction. A deposit value indicator 1002 represents an example standardized deposit value in Canadian dollars that may be configured within the enterprise application module 300 to accommodate regional variations or to provide standalone incentives in regions without statutory deposit systems.

A third jurisdiction configuration 1030 represents Australia, which operates deposit return systems in most but not all states and territories. A first state 1031 representing Western Australia and a second state 1032 representing Queensland are illustrated as having the same statutory deposit value. Additional states such as Victoria and Tasmania, represented by indicator 1033, do not currently operate statutory deposit return systems. A deposit value indicator 1003 represents an example deposit value in Australian dollars that may be configured within the enterprise application module 300, which may be set higher than existing statutory deposit rates to encourage greater recycling participation.

The database of the deposit return management system 100 stores a plurality of jurisdiction identifiers, each jurisdiction identifier being associated with a respective jurisdiction-specific deposit configuration as described with reference to FIG. 5B. In jurisdictions with national deposit systems such as Germany 1010, deposit balances are transferable across all states within the jurisdiction due to the uniform regulatory framework. In jurisdictions with regional deposit systems such as Canada 1020 and Australia 1030, deposit balances may be restricted to the specific region in which they were earned to maintain compliance with regional regulatory requirements.

The enterprise application module 300 enables stakeholders to conFIG.deposit structures appropriate for each jurisdiction, accommodating national systems with uniform deposit values, regional systems with varying deposit values, and regions without statutory deposit systems where the deposit return management system 100 may function as a standalone incentive mechanism. The deposit configuration interface of the enterprise application module 300 enables deposit values to be set at levels equal to or exceeding statutory requirements, providing flexibility to enhance recycling incentives in targeted jurisdictions or regions. The system architecture enables expansion into regions currently without statutory deposit return systems by providing the infrastructure and incentive mechanisms necessary to promote recycling participation independently of regulatory mandates.

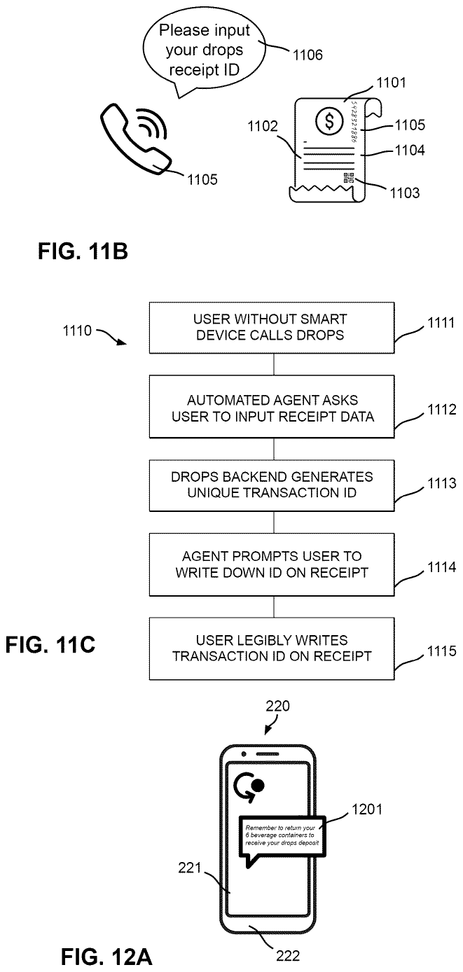

Referring now to FIG. 11A, there is illustrated a receipt processing component of the consumer application module 200 configured to associate purchased items with a user account using receipt data 1101. The receipt 1101 serves as a verification mechanism to ensure accuracy, enable integration with retailer systems, and provide fraud mitigation capabilities within the deposit return management system 100.

The receipt 1101 represents proof of purchase provided at a point of sale and contains transaction information 1102 detailing purchased items and deposit amounts paid during the transaction. The receipt 1101 may include a scannable code 1103 such as a QR code or other two-dimensional code that encodes transaction details for automated processing. In alternative embodiments, the receipt 1101 may lack a scannable code, and the system is configured to function using other verification methods in such cases.

The consumer application module 221 operates on the user computing device 222 and includes a camera module 423 configured to capture images of the receipt 1101. A recognition component 424B processes the captured image data to extract transaction information via optical character recognition or code scanning techniques. The consumer application module 221 additionally provides options for manual entry of receipt data or digital receipt creation in cases where automated scanning is unavailable or unsuccessful.

The partner application programming interface 400 facilitates connection between retailer point of sale systems and the network 101 to enable updating of user accounts during the purchase process. In a first operational mode, retailer point of sale systems integrated with the partner application programming interface 400 directly transfer transaction data to the user account during payment. The user's consumer application module 221 or membership identifier can be scanned at checkout, linking receipt details to the user account without requiring processing of a physical or digital receipt.

In a second operational mode utilizing encoded receipts, the receipt 1101 includes the scannable code 1103 that embeds purchase details. The consumer application module 221 scans the code 1103 and automatically updates the user account with the corresponding deposit information. In a third operational mode for non-integrated point of sale systems, the consumer application module 221 enables users to manually enter receipt data or capture an image of the receipt 1101 for digitization. The recognition component 424B employs optical character recognition technology to extract transaction details from the captured image and process them into the deposit return management system 100.

The receipt 1101 serves as a verification tool ensuring that only users who have completed legitimate purchases are credited with corresponding deposits. Each receipt 1101 is uniquely associated with a transaction within the database, reducing the risk of fraudulent claims for deposits. For retailers without internet connectivity or integration with the partner application programming interface 400, the receipt-based verification enables users to claim deposits via the consumer application module 221 in an offline-compatible manner.

Referring now to FIG. 11B, there is illustrated an automated telephony system configured to enable users to interact with the deposit return management system 100 without requiring a smartphone or the consumer application module 200. The automated telephony system provides an alternative method for users to validate purchases and connect deposits to their user accounts using standard telephone equipment.

The receipt 1101 acts as proof of purchase containing transaction details 1102 and a unique transaction identifier 1105 that can be used to identify the purchase within the deposit return management system 100. The receipt 1101 may additionally include a scannable code 1103 for alternative verification options and purchase details 1104 for user reference.

A telephone system component 1105 comprises a dedicated telephone line that enables users to interact with the deposit return management system 100 using standard telephone equipment. Users input receipt details and transaction identifiers through the telephone keypad using dual-tone multi-frequency signaling. Voice and text prompts 1106 provided by an automated voice response module guide the user through the verification process, requesting input of details such as the transaction identifier, deposit amounts, and purchased item information.

In operation, a user calls the automated telephony system using a telephone number printed on the receipt 1101 or product packaging. The user is prompted to input the transaction identifier 1105 from the receipt using the telephone keypad. Following voice prompts 1106, the user enters purchase information including deposit amounts, item details, and any unique codes from the receipt. The automated telephony system may generate an authorization code for the user to write on their receipt for subsequent validation purposes. Recycling centers or devices running the enterprise application module 300 can verify this authorization code during redemption operations.

The automated telephony system validates the provided information against data stored in the database and, upon successful validation, credits the corresponding deposit to the user account. Users may alternatively present the receipt and authorization code at a participating recycling center for manual verification, enabling participation without digital tools or internet connectivity.

The unique transaction identifier and authorization code provide security mechanisms ensuring that only valid receipts and purchases are credited within the deposit return management system 100. The automated telephony system expands participation to users without smartphones or internet access while maintaining fraud prevention through the combination of receipt data, transaction identifiers, and authorization codes.

Referring now to FIG. 11C, there is illustrated a flowchart depicting the sequential steps involved in verifying a purchase and linking it to a user account through the automated telephony system. The flowchart complements the functionality described with reference to FIG. 11B and illustrates the backend processes that enable non-smartphone users to interact with the deposit return management system 100.

A user interaction step 1111 represents a user without access to a smartphone calling the dedicated telephone line of the automated telephony system to initiate the verification process. An automated agent prompt step 1112 represents the automated voice response module requesting the user to input key receipt details such as the transaction identifier, deposit values, and other relevant purchase data using the telephone keypad.

A backend processing step 1113 represents the central processing system receiving the input data, validating the receipt information against transaction records stored in the database, and generating or confirming a unique transaction identifier tied to the specific purchase. An authorization code prompt step 1114 represents the automated voice response module providing the user with the generated or confirmed transaction identifier and prompting the user to write the identifier legibly on the receipt for future reference.

A receipt notation step 1115 represents the user writing the transaction identifier on their receipt, enabling subsequent manual or digital verification by the deposit return management system 100 or affiliated partners such as recycling centers. Upon completion of the telephone verification process, the user retains the annotated receipt for use during deposit redemption operations.

The transaction identifier written on the receipt enables recycling center personnel to verify the transaction against the deposit return management system 100 for deposit redemption. The unique transaction identifier ensures that receipts cannot be reused fraudulently for multiple deposit claims. The automated telephony system accommodates both manual verification at collection facilities and automated verification through devices running the enterprise application module 300, providing flexibility across diverse operational environments while ensuring accessibility for users with limited digital capabilities or access to smartphones.

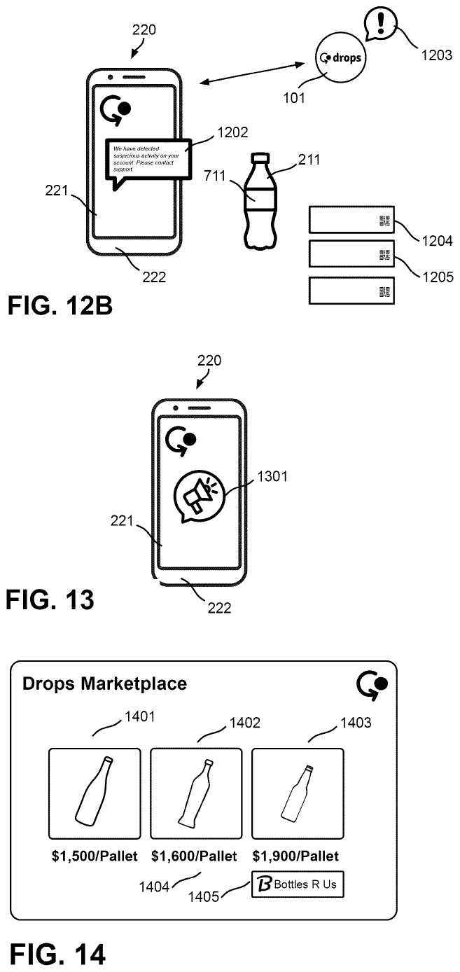

Referring now to FIG. 12A, there is illustrated a notification component of the consumer application module 200 configured to remind users to return recyclable or reusable items to receive deposit refunds. The illustrated configuration displays a user computing device 220 presenting the consumer application module interface 221 with a reminder notification 1201 generated by the central processing system to encourage user action regarding pending container returns.

The consumer application module 221 operates on the user computing device 222 and serves as the primary interface through which users interact with the deposit return management system 100. The reminder notification 1201 comprises a system-generated message that alerts the user about pending recyclable items associated with their user account. The reminder notification 1201 specifies actionable information such as the number of items with pending deposits and encourages the user to complete return operations to receive deposit refunds.

The central processing system tracks user purchases stored in the database and identifies items with pending deposits that have not yet been returned. Based on data associated with the user account including user profile information, location data, or purchase history, the central processing system generates and transmits the reminder notification 1201 to the consumer application module 200. The notification component provides actionable information regarding pending items, enabling users to act promptly on outstanding deposits.

The central processing system may adapt reminder frequencies and timing based on user behavior patterns stored in the database. The system may analyze historical response rates to notifications and adjust timing to optimize user engagement without generating excessive or intrusive notifications. Notifications may be triggered based on temporal factors such as elapsed time since purchase, spatial factors such as user proximity to collection facilities, or behavioral factors such as typical return patterns for the specific user.

The notification component integrates with data from point of sale systems connected via the partner application programming interface 400, collection facility systems, and user profile data stored in the database to provide accurate real-time information regarding pending deposits. The reminder notification 1201 may include functionality enabling users to view nearby collection facilities via the routing optimization component described with reference to FIG. 6B, facilitating completion of return operations in response to the notification.

Referring now to FIG. 12B, there is illustrated a fraud detection module of the central processing system configured to identify suspicious activities and alert users and system administrators regarding potentially fraudulent behavior. The fraud detection module monitors transaction data stored in the database for anomalous patterns and generates alerts upon detection of activities indicative of fraud such as replication of machine-readable identifiers or submission of counterfeit receipts.

The consumer application module 221 operates on the user computing device 220 and displays a suspicious activity alert 1202 when the fraud detection module identifies unusual or potentially fraudulent activity associated with the user account. The suspicious activity alert 1202 prompts the user to contact support or provide additional verification information to resolve the flagged activity.

The fraud detection module operates within the network 101 and employs detection algorithms to monitor activities including duplicate identifier scans, inconsistent redemption rates, geographic inconsistencies, and attempts to submit replicated receipts. Fraudulent identifiers 1204 and 1205 represent examples of replicated or counterfeit codes that may be created in attempts to exploit the deposit return management system 100. A scanned product 711 with a label 211 may be identified as bearing a potentially fraudulent or duplicated identifier through analysis by the fraud detection module.

The fraud detection module continuously monitors identifier scans, redemption patterns, and receipt uploads processed through the deposit return management system 100. Detection algorithms identify patterns indicative of fraud such as repeated use of the same identifier across multiple redemption attempts, discrepancies between purchase data and redemption data, redemption rates exceeding normal parameters for a single user or location, and geographic patterns inconsistent with legitimate usage.

Upon detection of anomalous patterns, the fraud detection module generates alerts that may be transmitted to multiple destinations. A user notification transmitted to the consumer application module 200 alerts the user via the suspicious activity alert 1202, requesting additional verification or advising the user to contact support. A verification notification 1203 may be transmitted to personnel operating the enterprise application module 300 for manual analysis of flagged activities to distinguish false positives from deliberate fraud attempts.

The fraud detection module may initiate fraud prevention actions including freezing user accounts pending verification, blocking specific identifiers from further redemption processing, requiring additional proof of purchase for flagged transactions, or escalating cases to human reviewers for detailed analysis. The fraud detection module is configured to scale across diverse jurisdictions and user populations while maintaining consistent detection capabilities across the deposit return management system 100.

Referring now to FIG. 13, there is illustrated an advertisement component of the consumer application module 200 configured to display personalized promotional content to users based on recycling and purchasing behavior data. The consumer application module 221 operates on the user computing device 222 and includes interface elements for presenting targeted advertisements and promotional messages to users.

An advertisement indicator 1301 comprises a visual element displayed within the consumer application module interface 221 that signals the presence of targeted advertisements or promotional content. The advertisement indicator 1301 may be represented as an icon or notification element that directs user attention to available promotional offers.

The central processing system includes an advertisement selection component that analyzes user data stored in the database to identify relevant promotional content for display to individual users. The advertisement selection component processes data including item types recycled by the user, redemption frequency patterns, purchasing trends derived from transaction records, and other behavioral indicators stored in association with the user account. Based on this analysis, the advertisement selection component selects relevant advertisements or promotions from partner brands or retailers for display within the consumer application module 200.

Selected advertisements are displayed within the consumer application module interface 221 as notifications or within dedicated display areas integrated into the application interface. The advertisement component is configured to present promotional content without disrupting primary user interactions with deposit tracking and redemption functionality. The central processing system tracks user interactions with displayed advertisements, including selection events and resulting transactions, to refine subsequent advertisement targeting and improve relevance of promotional content presented to users.

The advertisement component supports multiple categories of promotional content including product promotions for items aligned with sustainability objectives such as reusable containers or environmentally conscious products, retailer offers providing discounts or promotions from retailers where users frequently conduct transactions based on receipt data, recycling incentives offering enhanced deposit values or bonus credits for increased recycling activity, and informational content regarding sustainability practices or environmental initiatives.

Partner brands and retailers may provide promotional content for display through the advertisement component, with the deposit return management system 100 facilitating connections between users and partners based on behavioral alignment and user preferences. The advertisement component generates data regarding user engagement with promotional content that may be utilized for system analytics and partner reporting purposes.

Referring now to FIG. 14, there is illustrated a marketplace component of the enterprise application module 300 configured to enable stakeholders such as deposit return system operators, manufacturers, and retailers to procure containers including reusable bottles through a centralized platform. The marketplace component integrates procurement functionality with logistics tracking, sustainability metrics, and data management capabilities within the deposit return management system 100.

The marketplace component presents a marketplace interface displaying available containers for procurement by authorized stakeholders. Product listings 1401, 1402, and 1403 represent available container products with variations in design specifications and pricing. In the illustrated embodiment, pricing is displayed on a per-pallet basis, enabling bulk procurement appropriate for commercial and industrial stakeholders.

A seller integration component 1405 enables multiple vendors to list container products within the marketplace interface. Vendors may include container manufacturers, distributors, or the operator of the deposit return management system 100 itself. The marketplace component supports comparison of prices, designs, and specifications between products from multiple vendors, enabling stakeholders to identify containers matching their operational and sustainability requirements.

Containers procured through the marketplace component may be supplied with pre-applied machine-readable identifiers compatible with the deposit return management system 100. These pre-marked containers include unique codes enabling immediate integration into the system for traceability and user interaction upon deployment. The pre-marking of containers during or prior to procurement streamlines the deployment process for stakeholders launching new deposit return initiatives or expanding existing programs.

The marketplace component integrates with the database and network 101 to synchronize purchase and transportation data with the central processing system. Information regarding container procurement, shipping, and delivery is automatically recorded within the database to support extended producer responsibility compliance tracking and data analytics. The central processing system calculates extended producer responsibility contributions and sustainability metrics based on procurement and deployment data, automating regulatory compliance reporting for stakeholders.

Stakeholders access the marketplace component through the enterprise application module 300 and place orders directly within the application interface, selecting container types and quantities appropriate for their operational requirements. The marketplace component transmits order data to vendors and tracks fulfillment status, providing stakeholders with visibility into procurement operations. Upon delivery, containers are registered within the deposit return management system 100 with their pre-applied identifiers, enabling immediate tracking of distribution, use, and eventual return or recycling throughout the container lifecycle.

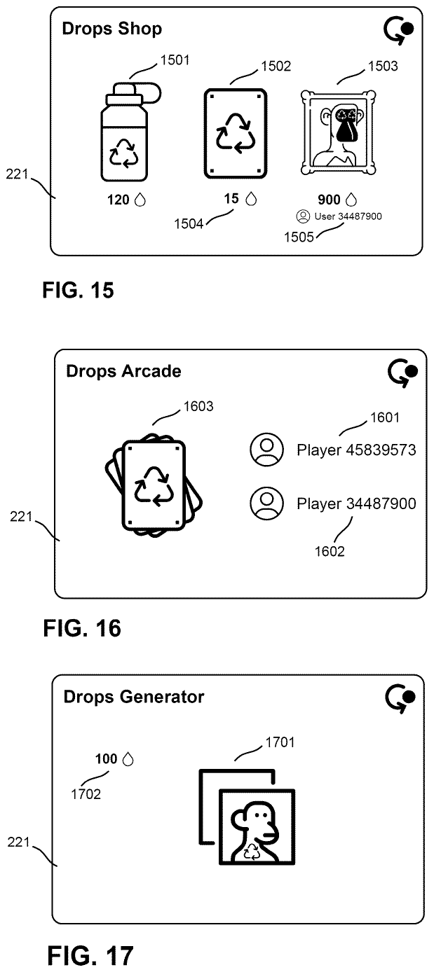

Referring now to FIG. 15, there is illustrated a redemption and marketplace component of the consumer application module 200 configured to enable users to redeem accumulated deposit credits for various items including physical products and digital assets, and to facilitate resale of previously acquired items between users. The redemption and marketplace component provides a multifunctional platform within the deposit return management system 100 where users can convert deposit credits into tangible rewards while participating in a secondary marketplace for acquired items.

The redemption and marketplace component presents multiple categories of redeemable items to users through the consumer application module interface 221. A physical item listing 1501 represents tangible products available for redemption, such as reusable beverage containers, which may be redeemed for a specified quantity of deposit credits. A digital trading card listing 1502 represents collectible digital assets that may be redeemed for deposit credits and utilized within gamification features of the consumer application module 200 or traded within the user community. A digital artwork listing 1503 represents unique digital assets that may be generated based on user activity data or created as rewards for active participation in the deposit return management system 100.

A resale component 1505 enables users to list previously acquired items for resale within the marketplace interface. Items listed for resale include metadata such as the seller's user identifier to verify ownership and facilitate secure transactions between users. The resale component supports listing of both physical items and digital assets, enabling users to monetize previously acquired rewards when desired.

In operation, users browse the marketplace interface and select items for redemption using deposit credits from their user account balance. Redeemed digital items are added to the user's digital asset repository within their user account, while physical items are processed for delivery to the user. Users may list previously acquired items for resale by specifying an asking price in deposit credits and providing the item for listing within the marketplace interface. Other users may browse resale listings and purchase items, with deposit credits transferred from the purchasing user's account to the selling user's account upon completion of the transaction.

The redemption and marketplace component supports dynamic pricing for resale items, wherein prices may vary based on demand, rarity attributes stored in the database, and user-specified values. The central processing system ensures authenticity of items listed for resale by verifying ownership records stored in the database and facilitates secure exchange of deposit credits during resale transactions. The marketplace component may support alternative credit types in addition to deposit credits, such as loyalty points or other reward currencies, for specific purchases or resale transactions.

Referring now to FIG. 16, there is illustrated a gamification module of the consumer application module 200 configured to provide interactive gaming functionality that utilizes deposit credits and associated digital assets such as trading cards. The gamification module is integrated into the consumer application module 221 and provides users with gameplay opportunities that incentivize continued participation in recycling activities within the deposit return management system 100.

Player profile components 1601 and 1602 represent user identities within the gamification module, enabling users to participate in games and challenges. Each player profile is associated with a user account and tracks achievements, performance metrics, and progress within the gaming functionality. The player profiles are linked to the user account data stored in the database, enabling correlation between recycling activity and gaming participation.

Digital trading card assets 1603 represent collectible digital items that users may acquire through redemption of deposit credits, as rewards for recycling activity, or through the marketplace component described with reference to FIG. 15. The digital trading cards 1603 include attribute data such as rarity levels and functional characteristics that affect gameplay within the gamification module. Users may accumulate collections of digital trading cards and utilize them within games offered through the gamification module.

The gamification module presents a gaming interface accessible through the consumer application module 221, enabling users to view available games and initiate gameplay sessions. Games within the gamification module may involve strategic elements, chance elements, or combinations thereof, utilizing the attributes of digital trading cards 1603 held by participating users. Users may compete against other users represented by player profiles 1601 and 1602, or against system-controlled opponents.

The gamification module awards rewards to users based on gameplay outcomes, including additional deposit credits, digital trading cards of varying rarity levels, or other digital assets. The reward structure encourages continued participation in both gaming activities and recycling behaviors within the deposit return management system 100. Users may challenge specific other users or be matched with opponents through automated matching functionality. Leaderboard functionality tracks and displays user rankings based on gaming performance, fostering competitive engagement among participants.

The gamification module includes customization functionality enabling users to personalize their player profiles and organize collections of digital trading cards into configured groupings for use in gameplay. Performance within games may unlock exclusive rewards or access to additional content, creating connections between gaming engagement and participation in the broader deposit return management system 100. The gamification module maintains digital asset repositories for each user account, storing acquired digital trading cards and other collectible items in association with the user's profile data in the database.

The central processing system 102 may further comprise a gamified marketplace module configured to incentivize recycling participation through digital rewards and marketplace access. The gamified marketplace module is configured to generate or unlock digital assets, rewards, or collectibles based on verified recycling activity, such that users who return containers through the deposit return management system 100 receive digital items including but not limited to badges, tokens, digital trading cards, or unique digital artworks. The gamified marketplace module is further configured to enable users to trade, bid for, or purchase goods or services within an integrated marketplace, wherein users may exchange earned rewards for physical goods, services, promotional offers, or digital items offered by participating merchants or the system operator. The gamified marketplace module may restrict access to certain marketplace features based on a user's recycling participation level, such that users who achieve threshold recycling activity levels gain access to exclusive items, premium marketplace sections, early access to new offerings, or enhanced trading privileges. This tiered access structure provides additional incentive for sustained recycling participation within the deposit return management system 100.

Referring now to FIG. 17, there is illustrated a digital asset generation component of the consumer application module 200 configured to enable users to redeem accumulated deposit credits for the creation of unique digital assets. The digital asset generation component provides functionality that enables users to convert deposit credits into personalized digital creations, linking recycling participation within the deposit return management system 100 to creative digital rewards.

A generated asset display 1701 represents a digital creation produced by the digital asset generation component, such as an avatar, digital artwork, collectible image, or other digital item. Generated assets may incorporate unique designs, features, or thematic elements that are associated with the user's recycling activities or preferences stored in the user account data within the database. Each generated asset is unique and linked to the user account of the user who initiated the generation request.

A deposit credit cost indicator 1702 displays the quantity of deposit credits required to generate a particular asset type. The consumer application module interface 221 presents the cost indicator 1702 to ensure transparency regarding the deposit credit expenditure associated with asset generation. Different asset types or customization options may require varying quantities of deposit credits, enabling users to select generation options appropriate to their accumulated credit balance.

The digital asset generation component includes personalization functionality that enables generated assets to be customized based on user preferences or recycling history data stored in the database. Users may specify thematic preferences, design elements, or other customization parameters that influence the characteristics of the generated asset. The digital asset generation component may additionally incorporate data regarding the user's recycling activities, such as quantities or types of containers returned, into the design or attributes of generated assets.

In operation, users access the digital asset generation component through the consumer application module 221 and browse available asset generation options presented in the interface. Each generation option displays associated design characteristics and the deposit credit cost required for generation. Upon user selection and confirmation of a generation request, the central processing system processes the request, deducts the appropriate quantity of deposit credits from the user account balance, and generates the digital asset. The generated asset is linked to the user account and stored in the digital asset repository associated with the user for immediate access, display, or subsequent use.

Generated assets may be utilized within other components of the consumer application module 200, such as the gamification module described with reference to FIG. 16, or displayed within the user's profile. The digital asset generation component integrates with the marketplace component described with reference to FIG. 15, enabling users to list generated assets for trade or resale within the marketplace interface. Users may additionally share generated assets through external platforms or transfer assets to other users within the deposit return management system 100.

The digital asset generation component stores metadata regarding each generated asset in the database, including the generating user's identifier, generation timestamp, customization parameters applied, and deposit credit cost expended. This metadata enables verification of asset authenticity and ownership for subsequent trading or transfer operations. The central processing system maintains records of all generated assets and their current ownership status, facilitating secure transactions involving generated digital assets within the deposit return management system 100.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configuration of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A deposit return management system comprising:
a central processing system comprising at least one processor and at least one memory, the central processing system configured to manage data communications and transaction processing;
a database in communication with the central processing system, the database configured to store container identification data, user account data, deposit configuration data, and transaction records;
an enterprise application module in communication with the central processing system, the enterprise application module comprising:
a deposit configuration interface configured to receive input defining a deposit structure, wherein the deposit structure comprises at least a consumer deposit value and one or more stakeholder fees or deposits, wherein the deposit configuration interface is configured to define an allocation of the one or more stakeholder fees or deposits among a plurality of stakeholder entities; and
a stakeholder management component configured to store and maintain data associating each of the plurality of stakeholder entities with a respective portion of the deposit value;
a consumer application module configured to operate on a user computing device, the consumer application module configured to capture machine readable identifier data and communicate with the central processing system, the consumer application module comprising:
a user account component configured to maintain data relating to a user account including a deposit balance; and
a partner application programming interface in communication with the central processing system, the partner application programming interface configured to exchange data with one or more external systems; and
wherein the central processing system is configured to receive the captured identifier data from the consumer application module, retrieve container data from the database corresponding to the captured identifier data, and associate the container with the user account based on the captured identifier data.

2. The deposit return management system of claim 1, wherein the enterprise application module further comprises a system design interface configured to receive input defining a plurality of stakeholder roles and one or more operational relationships between the plurality of stakeholder roles.

3. The deposit return management system of claim 2, wherein the system design interface further comprises a visual workspace component configured to display a graphical representation of the plurality of stakeholder roles and the one or more operational relationships.

4. The deposit return management system of claim 1, wherein the enterprise application module further comprises an extended producer responsibility dashboard configured to retrieve stakeholder-specific data from the database and generate compliance status information based on jurisdictional regulatory requirements.

5. The deposit return management system of claim 4, wherein the extended producer responsibility dashboard further comprises a metrics display component configured to retrieve and display a plurality of performance metrics including at least one of a materials collection quantity, an items collection count, a carbon emissions savings value, and a user participation count.

6. The deposit return management system of claim 1, wherein the enterprise application module further comprises an analytics module configured to receive operational data from a plurality of collection facilities and generate one or more operational recommendations based on a comparison of performance metrics between the plurality of collection facilities.

7. The deposit return management system of claim 1, wherein the enterprise application module further comprises an inventory management module configured to track inventory levels for a plurality of single use and/or reusable containers and generate restocking recommendations based on calculated return rates and/or usage rates.

8. The deposit return management system of claim 1, wherein the consumer application module further comprises a dynamic deposit adjustment component configured to receive user input selecting or accepting a deposit value for a container and transmit the selected deposit value to the central processing system.

9. The deposit return management system of claim 1, wherein the database is configured to store a plurality of jurisdiction identifiers each associated with a respective jurisdiction-specific deposit configuration, and wherein the consumer application module is configured to maintain a plurality of separate deposit balances for the user account corresponding to respective jurisdiction identifiers.

10. The deposit return management system of claim 1, wherein the central processing system further comprises a dynamic pricing module configured to calculate an adjusted deposit value based on real-time data relating to at least one of recycling rates, material demand, and environmental impact metrics.

11. The deposit return management system of claim 1, wherein the machine-readable identifier comprises one or more of: a primary identifier disposed on a first surface of the container, a secondary identifier disposed on a second surface of the container, and a tertiary identifier disposed on a third surface of the container, wherein the identifier recognition component is configured to capture identifier data from any one or any combination of the one or more identifiers.

12. The deposit return management system of claim 1, wherein the machine-readable identifier comprises a circumferential code disposed around a circumference of the container, the circumferential code comprising a repeating sequential pattern including a plurality of visual orientation markers and a plurality of data elements.

13. The deposit return management system of claim 1, further comprising a crate assembly comprising a crate body configured to hold a plurality of containers, wherein the crate body comprises a plurality of apertures positioned to expose machine-readable identifiers disposed on respective surfaces of the plurality of containers.

14. The deposit return management system of claim 13, further comprising a machine vision system comprising at least one imaging device positioned to capture images of the machine-readable identifiers through the plurality of apertures, wherein the machine vision system is in communication with the central processing system via the partner application programming interface.

15. The deposit return management system of claim 1, wherein the partner application programming interface is configured to receive transaction data from a point of sale system and receive user identification data obtained from at least one of a scanned code displayed by the consumer application module and a near-field communication exchange with the user computing device.

16. The deposit return management system of claim 1, wherein the consumer application module or the central processing system further comprises a participation and device-interoperability component configured to enable a user to activate a deposit return or earn alternative credits by depositing a container through at least one of: (i) a collection device integrated with the deposit return management system, (ii) a collection device partially integrated with the deposit return management system, (iii) a collection device not integrated with the deposit return management system, or (iv) a device operated by a recycling center operator or other authorized party; wherein the participation and device-interoperability component is configured to receive at least one of: a device-generated code, a transaction identifier, a receipt-derived identifier extracted using optical character recognition, an item image, a sensor reading, a telephony-based confirmation signal, or a machine-to-device communication token; and wherein the central processing system is configured to validate the return, log the transaction, and issue at least one of a deposit credit, alternative credit, reward, or purchase authorization based on the received information.

17. The deposit return management system of claim 1, further comprising an automated telephony system in communication with the central processing system, the automated telephony system configured to receive transaction identifier input from a user via telephone keypad signals and generate a unique authorization code.

18. The deposit return management system of claim 1, wherein the central processing system further comprises a fraud detection module configured to monitor transaction data stored in the database for anomalous patterns and generate an alert upon detection of an anomalous pattern.

19. The deposit return management system of claim 1, wherein the central processing system further comprises a volume prediction module configured to apply a predictive model to historical collection data to generate predicted collection volumes for a plurality of collection facilities.

20. The deposit return management system of claim 1, wherein the central processing system further comprises a gamified marketplace module configured to perform one or more of: (i) generating or unlocking digital assets, rewards, or collectibles based on verified recycling activity; (ii) enabling users to trade, bid for, or purchase goods or services within an integrated marketplace; and (iii) restricting access to marketplace features based on a user's recycling participation level.
